(19) United States
(12) Patent Application Publication
(10) Pub. No.: US 2026/0100798 A1
(43) Pub. Date: Apr. 9, 2026

(54) WIRELESS COMMUNICATION METHOD AND RELATED APPARATUS

(71) Applicant: Huawei Technologies Co., Ltd., Shenzhen (CN)

(72) Inventors: Mahmoud Hasabelnaby, Ottawa (CA); Jung Hoon Suh, Ottawa (CA); Osama Aboul-Magd, Ottawa (CA); Yan Xin, Kanata (CA); Sara Norouzi, Vancouver (CA)

(21) Appl. No.: 18/971,866

(22) Filed: Dec. 6, 2024

Related U.S. Application Data
(63) Continuation of application No. PCT/CN2024/123321, filed on Oct. 8, 2024.

(51) Int. Cl. H04L 5/00

(52) U.S. Cl. CPC H04L 5/0053

(57) ABSTRACT

Provided are a wireless communication method and related apparatus. In the method, a frame carrying the indication information for TB A-PPDU combinations can be transmitted. By defining a reserved combination of the first field and the second field (e.g., the UL BW subfield and the UL BW Extension subfield) to indicate the channel for transmission of different types of PPDUs in the TB A-PPDU, it can support a wider range of TB A-PPDU combinations.

### CROSS-REFERENCE TO RELATED APPLICATIONS

This application is a continuation of International Application No. PCT/CN2024/123321, filed on Oct. 8, 2024, the disclosure of which is hereby incorporated by reference in its entirety.

### TECHNICAL FIELD

The present disclosure relates to the field of technologies of communication, and in particular, to a wireless communication method and related apparatus.

### BACKGROUND

The wireless local area network (WLAN) technology has evolved from the 802.11a/b/g, 802.11n, 802.11ac, 802.11ax and 802.11be standards to the 802.11bn standard. This comes with continuous increase of data throughput. From this perspective, the 802.11ax standard is also referred to as the high efficiency (HE) wireless standard, the 802.11be standard is also referred to as the extremely high throughput (EHT) wireless standard, and the 802.11bn standard is also referred to as the ultra-high reliability (UHR) wireless standard.

A physical layer protocol data unit (PHY Protocol Data Unit, PPDU) is a frame format widely used in a WLAN system, and may be used for data transmission between WLAN nodes such as an access point (AP) and a terminal device (STA).

This background information is provided to reveal information believed by the applicant to be of possible relevance to the present disclosure. No admission is necessarily intended, nor should be construed, that any of the preceding information constitutes prior art against the present disclosure.

### SUMMARY

According to a first aspect, an embodiment of the present disclosure provides a wireless communication method, comprising:
transmitting a frame, where the frame is used for requesting transmission of plural physical layer (PHY) protocol data units (PPDU), and the frame comprises a first field indicating bandwidth information for the transmission of the plural PPDUs and a second field indicating bandwidth extended information for transmission of at least one of the plural PPDUs; where a channel for the transmission of the at least one of the plural PPDUs is indicated through a reserved combination of the first field and the second field.

The method can be applied to an access point (AP). The AP transmits the frame carrying the indication information for TB A-PPDU combinations, and then the STA(s) can transmit the required TB PPDU(s) to the AP in response to the received frame. By defining a reserved combination of the first field and the second field (e.g., the UL BW subfield and the UL BW Extension subfield) to indicate the channel for transmission of different types of PPDUs in the TB A-PPDU, it can support a wider range of TB A-PPDU combinations, so different combinations can be chosen to meet different requirements in different application scenarios, the flexibility of the system can thus be improved. Based on the unified signaling method, triggering of one or more lower generation PPDUs and one or more higher generation PPDUs from same or different generations of STAs can be achieved. The signaling method can accommodate a wider range of TB A-PPDU combinations, ensuring greater flexibility, scalability, and potential performance benefits. The proposed signaling method can be applicable to UHR APs and STAs (APs and STAs supporting the 802.11bn standard) or devices supporting future standards.

In a possible design, the at least one PPDU of the plural PPDUs is requested to be transmitted on a secondary channel, and the plural PPDUs include a PPDU requested to be transmitted on a primary channel and the at least one PPDU.

In a possible design, the frame further comprises a third field indicates whether a high efficiency (HE) PPDU from a HE station (STA) or a non-HE PPDU from a non-HE STA is requested to be present on a primary 160 MHz channel.

The channel indication for the TB A-PPDU UHR combinations can be implemented by the third field, e.g., the Bit 54 (B54) of the Common Info field.

In a possible design, the plural PPDUs comprise the at least one of the plural PPDUs and the HE PPDU, and the third field indicates that the HE PPDU is present on the primary 160 MHz channel; where a channel for transmission of the HE PPDU by a non-access point (non-AP) HE STA is a primary 80 MHz channel within the primary 160 MHz channel, and is indicated by the first field.

The primary 80 MHz channel within the primary 160 MHz channel means the HE PPDU is in P80 of P160, and this specific location of the HE PPDU within P160 is indicated by the first field. For the case of HE PPDU in P80, while the third field indicates the presence of the HE PPDU in P160, the first field can be further used to further locate P80 in P160. It should be noted that for the case of HE PPDU in P160, the third field per se would be enough for indicating the channel on which the requested PPDU should be present, in this case, the first field can be set according to protocol for confirmation purpose, thereby improving the accuracy of bandwidth indication for the solicited PPDU.

In a possible design, the plural PPDUs comprise the at least one of the plural PPDUs and the non-HE PPDU, and the third field indicates that the non-HE PPDU is present on the primary 160 MHz channel; where a channel for transmission of the non-HE PPDU by the non-HE STA is a primary 80 MHz channel within the primary 160 MHz channel, and is indicated by the first field and the second field.

The primary 80 MHz channel within the primary 160 MHz channel means the non-HE PPDU is in P80 of P160, and this specific location of the non-HE PPDU within P160 is indicated by the first field and the second field. The indication of non-HE PPDU in P160 can be achieved by the third field per se, but the indication of non-HE PPDU in P80 would be achieved based on the first field and the second field when the third field indicates that the non-HE PPDU is present on the primary 160 MHz channel. That is, for both cases of HE PPDU and non-HE PPDU, the third field (e.g., B54 of the Common Info field) is necessary; and the bandwidth of the non-HE PPDU is indicated by both the first field (e.g., the UL BW subfield in the Common Info field) and the second field (e.g., the UL BW Extension subfield in the Special User Info field), while the bandwidth of the HE PPDU is indicated by the first field (e.g., the UL BW subfield in the Common Info field).

In a possible design, the at least one of the plural PPDUs comprises one or more of: an HE PPDU requested to be transmitted on a secondary 80 MHz channel by a non-AP ultra-high reliability (UHR) station (STA) in response to reception of the frame;
an EHT PPDU requested to be transmitted on a secondary 80 MHz channel or a secondary 160 MHz channel by a non-AP UHR STA in response to reception of the frame;
a UHR PPDU requested to be transmitted on a secondary 80 MHz channel or a secondary 160 MHz channel by a non-AP UHR STA in response to reception of the frame.

In a possible design, the frame further comprises a physical layer (PHY) Version Identifier subfield corresponding to each of the at least one of the plural PPDUs for indicating a type of each of the at least one of the plural PPDUs.

The PPDU type in the TB A-PPDU can also be indicated by the PHY Version Identifier subfield, reserved values of the PHY Version Identifier subfield can be utilized to define a wider range of PPDU types, e.g., any variant PPDU.

In a possible design, the at least one of the plural PPDUs comprises one PPDU, and a type of the one PPDU is indicated by a reserved value for the PHY Version Identifier subfield corresponding to the one PPDU.

In a possible design, the at least one of the plural PPDUs comprises more than one PPDU, and types of different PPDUs among the more than one PPDU are indicated by different values carried in PHY Version Identifier subfields corresponding to the more than one PPDU respectively.

One of the reserved bits within the Common field (sixth field) can be utilized to indicate the presence of more than one Special User Info fields, thereby improving the decoding accuracy.

In a possible design, the frame further indicates a presence of Special User Info fields comprising the PHY Version Identifier subfields respectively.

One of the reserved bits within the Common field can be utilized to indicate the presence of more than one Special User Info fields, thereby improving the decoding accuracy.

In a possible design, the PHY Version Identifier subfield is assigned with a value of 1 for indicating a type of a requested PPDU being a UHR PPDU or a HE PPDU from a non-AP UHR STA.

In a possible design, the PHY Version Identifier subfield is assigned with a value of 7 for indicating a type of a requested PPDU being a HE PPDU from a non-AP UHR STA.

In a possible design, remaining reserved values within the PHY Version Identifier subfield are kept reserved for indicating other PPDU variant(s).

In other words, the remaining reserved values within the PHY Version Identifier subfield, which are not defined with specific meanings, are kept reserved for future use, such as indicating upcoming future PPDU variant(s), including those intended for Wi-Fi 9 and beyond.

In a possible design, the channel indicated through the reserved combination of the first field and the second field is a secondary 80 MHz channel or a secondary 160 MHz channel.

In a possible design, in the reserved combination of the first field and the second field for indicating the secondary 80 MHz channel, the first field is assigned with a value of 2 and the second field is assigned with a value of 1 or 3.

In a possible design, in the reserved combination of the first field and the second field for indicating the secondary 160 MHz channel, the first field is assigned with a value of 2 and the second field is assigned with a value of 2.

In a possible design, in the reserved combination of the first field and the second field for indicating the secondary 160 MHz channel, the first field is assigned with a value of 3 and the second field is assigned with a value of 0.

In a possible design, bit 12 (B12) and bit 39 (B39) in a fourth field are re-purposed for other information.

In an example, the fourth field can be a UHR User Info field, B12 and B39 in the UHR User Info field can be re-purposed for defining other UHR information.

In a possible design, when the at least one PPDU comprises a UHR PPDU and an EHT PPDU, the frame further comprises a fifth field between a UHR User Info field carrying user information of the UHR PPDU and a Special User Info field corresponding to the EHT PPDU; where the fifth field carries a frame check sequence (FCS) for the UHR PPDU.

In this case, UHR STA will decode only its UHR Special User Info field, its UHR User Info field, and a corresponding FCS user Info field, thereby reducing the amount of data to be processed, and improving the decoding efficiency.

In a possible design, the frame further indicates that the at least one PPDU comprises the UHR PPDU and the EHT PPDU.

In a possible design, the indication of the at least one PPDU comprising the UHR PPDU and the EHT PPDU is carried in a Common Info field of the frame.

One of the reserved bits within the Common field can be utilized to indicate the TB A-PPDU with EHT PPDU+UHR PPDU.

In a possible design, the first field is an uplink (UL) Bandwidth field in the frame.

In a possible design, the second field is an UL Bandwidth Extension subfield corresponding to the at least one of the plural PPDUs.

According to a second aspect, an embodiment of the present disclosure provides a wireless communication method, comprising:
receiving a frame, where the frame is used for requesting transmission of plural physical layer (PHY) protocol data units (PPDU), and the frame comprises a first field indicating bandwidth information for the transmission of the plural PPDUs and a second field indicating bandwidth extended information for transmission of at least one of the plural PPDUs; where a channel for the transmission of the at least one of the plural PPDUs is indicated through a reserved combination of the first field and the second field;
transmitting a PPDU among the plural PPDUs based on the frame.

The method can be applied to a station (STA). The AP transmits the frame carrying the indication information for TB A-PPDU UHR combinations, and then the STA(s) can transmit the required TB PPDU(s) to the AP in response to the received TB A-PPDU frame. By defining a reserved combination of the first field and the second field (e.g., the UL BW subfield and the UL BW Extension subfield) to indicate the channel for transmission of different types of PPDUs in the TB A-PPDU, it can support a wider range of TB A-PPDU for potential UHR combinations.

In a possible design, the at least one PPDU of the plural PPDUs is requested to be transmitted on a secondary channel, and the plural PPDUs include a PPDU requested to be transmitted on a primary channel and the at least one PPDU. In this case, the PPDU among the plural PPDUs can be the PPDU requested to be transmitted on the primary channel, or one or more of the at least one PPDU requested to be transmitted on the secondary channel.

In a possible design, the frame further comprises a third field indicates whether a high efficiency (HE) PPDU from a HE station (STA) or a non-HE PPDU from a non-HE STA is requested to be present on a primary 160 MHz channel.

The channel indication for the TB A-PPDU UHR combinations can be implemented by the third field, e.g., the Bit 54 (B54) of the Common Info field.

In a possible design, the plural PPDUs comprise the at least one of the plural PPDUs and the HE PPDU, and the third field indicates that the HE PPDU is present on the primary 160 MHz channel; where a channel for transmission of the HE PPDU by a non-access point (non-AP) HE STA is a primary 80 MHz channel within the primary 160 MHz channel, and is indicated by the first field.

The primary 80 MHz channel within the primary 160 MHz channel means the HE PPDU is in P80 of P160, and this specific location of the HE PPDU within P160 is indicated by the first field. For the case of HE PPDU in P80, while the third field indicates the presence of the HE PPDU in P160, the first field can be further used to further locate P80 in P160. It should be noted that for the case of HE PPDU in P160, the third field per se would be enough for indicating the channel on which the requested PPDU should be present, in this case, the first field can be set according to protocol for confirmation purpose, thereby improving the accuracy of bandwidth indication for the solicited PPDU.

In a possible design, the plural PPDUs comprise the at least one of the plural PPDUs and the non-HE PPDU, and the third field indicates that the non-HE PPDU is present on the primary 160 MHz channel; where a channel for transmission of the non-HE PPDU by the non-HE STA is a primary 80 MHz channel within the primary 160 MHz channel, and is indicated by the first field and the second field.

The primary 80 MHz channel within the primary 160 MHz channel means the non-HE PPDU is in P80 of P160, and this specific location of the non-HE PPDU within P160 is indicated by the first field and the second field. The indication of non-HE PPDU in P160 can be achieved by the third field per se, but the indication of non-HE PPDU in P80 would be achieved based on the first field and the second field when the third field indicates that the non-HE PPDU is present on the primary 160 MHz channel. That is, for both cases of HE PPDU and non-HE PPDU, the third field (e.g., B54 of the Common Info field) is necessary; and the bandwidth of the non-HE PPDU is indicated by both the first field (the UL BW subfield in the Common Info field) and the second field (e.g., the UL BW Extension subfield in the Special User Info field), while the bandwidth of the HE PPDU is indicated by the first field (e.g., the UL BW subfield in the Common Info field).

In a possible design, the at least one of the plural PPDUs comprises one or more of: an HE PPDU requested to be transmitted on a secondary 80 MHz channel by a non-AP ultra-high reliability (UHR) station (STA) in response to reception of the frame;
an EHT PPDU requested to be transmitted on a secondary 80 MHz channel or a secondary 160 MHz channel by a non-AP UHR STA in response to reception of the frame;
a UHR PPDU requested to be transmitted on a secondary 80 MHz channel or a secondary 160 MHz channel by a non-AP UHR STA in response to reception of the frame.

In a possible design, the frame further comprises a physical layer (PHY) Version Identifier subfield corresponding to each of the at least one of the plural PPDUs for indicating a type of each of the at least one of the plural PPDUs.

The PPDU type in the TB A-PPDU can also be indicated by the PHY Version Identifier subfield, reserved values of the PHY Version Identifier subfield can be utilized to define a wider range of PPDU types, e.g., any variant PPDU.

In a possible design, the at least one of the plural PPDUs comprises one PPDU, and a type of the one PPDU is indicated by a reserved value for the PHY Version Identifier subfield corresponding to the one PPDU.

In a possible design, the at least one of the plural PPDUs comprises more than one PPDU, and types of different PPDUs among the more than one PPDU are indicated by different values carried in PHY Version Identifier subfields corresponding to the more than one PPDU respectively.

One of the reserved bits within the Common field can be utilized to indicate the presence of more than one Special User Info fields, thereby improving the decoding accuracy.

In a possible design, the frame further indicates a presence of Special User Info fields comprising the PHY Version Identifier subfields respectively.

One of the reserved bits within the Common field can be utilized to indicate the presence of more than one Special User Info fields, thereby improving the decoding accuracy.

In a possible design, the PHY Version Identifier subfield is assigned with a value of 1 for indicating a type of a requested PPDU being a UHR PPDU or a HE PPDU from a non-AP UHR STA.

In a possible design, the PHY Version Identifier subfield is assigned with a value of 7 for indicating a type of a requested PPDU being a HE PPDU from a non-AP UHR STA.

In a possible design, remaining reserved values within the PHY Version Identifier subfield are kept for indicating other PPDU variant(s).

In other words, the remaining reserved values within the PHY Version Identifier subfield are kept reserved for future use, such as indicating upcoming future PPDU variant(s), including those intended for Wi-Fi 9 and beyond.

In a possible design, the channel indicated through the reserved combination of the first field and the second field is a secondary 80 MHz channel or a secondary 160 MHz channel.

In a possible design, in the reserved combination of the first field and the second field for indicating the secondary 80 MHz channel, the first field is assigned with a value of 2 and the second field is assigned with a value of 1 or 3.

In a possible design, in the reserved combination of the first field and the second field for indicating the secondary 160 MHz channel, the first field is assigned with a value of 2 and the second field is assigned with a value of 2.

In a possible design, in the reserved combination of the first field and the second field for indicating the secondary 160 MHz channel, the first field is assigned with a value of 3 and the second field is assigned with a value of 0.

In a possible design, bit 12 (B12) and bit 39 (B39) in a fourth field are re-purposed for other information.

In an example, the fourth field can be a UHR User Info field, B12 and B39 in the UHR User Info field can be re-purposed for defining other UHR information.

In a possible design, when the at least one PPDU comprises a UHR PPDU and an EHT PPDU, the frame further comprises a fifth field between a UHR User Info field carrying user information of the UHR PPDU and a Special User Info field corresponding to the EHT PPDU; where the fifth field carries a frame check sequence (FCS) for the UHR PPDU.

In this case, UHR STA will decode only its UHR Special User Info field, its UHR User Info field, and a corresponding FCS user Info field, thereby reducing the amount of data to be processed, and improving the decoding efficiency.

In a possible design, the frame further indicates that the at least one PPDU comprises the UHR PPDU and the EHT PPDU.

In a possible design, the indication of the at least one PPDU comprising the UHR

PPDU and the EHT PPDU is carried in a Common Info field of the frame.

One of the reserved bits within the Common field can be utilized to indicate the TB A-PPDU with EHT PPDU+UHR PPDU.

In a possible design, the first field is an uplink (UL) Bandwidth field in the frame.

In a possible design, the second field is an UL Bandwidth Extension subfield corresponding to the at least one of the plural PPDUs.

According to a third aspect, a communication apparatus is provided by an embodiment of the present disclosure, and the communication apparatus has a function of implementing the first aspect. For example, the communication apparatus includes a corresponding module, unit or means for performing operations in the first aspect. The module, unit or means maybe specifically implemented by using software, may be implemented by using hardware, or may be implemented by using software in combination with hardware.

According to a fourth aspect, a communication apparatus is provided by an embodiment of the present disclosure, and the communication apparatus has a function of implementing the second aspect. For example, the communication apparatus includes a corresponding module, unit or means for performing operations in the second aspect. The module, unit or means maybe specifically implemented by using software, may be implemented by using hardware, or may be implemented by using software in combination with hardware.

According to a fifth aspect, another communication apparatus is provided by an embodiment of the present disclosure. The communication apparatus includes one or more processors. A memory is configured to store a part or all of a necessary computer program or instructions for implementing a function in the first aspect. The one or more processors may execute the computer program or the instructions, and when the computer program or the instructions is/are executed, the communication apparatus is enabled to implement the method in any possible design or implementation of the first aspect.

In a possible design, the communication apparatus may further include an interface circuit, and the processor is configured to communicate with another apparatus or component through the interface circuit.

In a possible design, the apparatus may further include the memory.

According to a sixth aspect, another communication apparatus is provided by an embodiment of the present disclosure. The communication apparatus includes one or more processors. A memory is configured to store a part or all of a necessary computer program or instructions for implementing a function in the second aspect. The one or more processors may execute the computer program or the instructions, and when the computer program or the instructions is/are executed, the communication apparatus is enabled to implement the method in any possible design or implementation of the second aspect.

In a possible design, the communication apparatus may further include an interface circuit, and the processor is configured to communicate with another apparatus or component through the interface circuit.

In a possible design, the apparatus may further include the memory.

The communication apparatus may be a terminal, a module in a terminal, or a chip responsible for a communication function in a terminal, for example, a modem chip (also referred to as a baseband chip) or an SoC chip or an SIP chip that includes a modem module.

According to a seventh aspect, an embodiment of the present disclosure provides a communication system, where the communication system includes a first apparatus configured to perform the method in any possible design or implementation of the first aspect, and a second apparatus configured to perform the method in any possible design or implementation of the second aspect.

According to an eighth aspect, an embodiment of the present disclosure provides a computer-readable storage medium. The computer-readable storage medium stores computer-readable instructions, and when a computer reads and executes the computer-readable instructions, the computer is enabled to perform the method in any one of the possible designs of the first aspect to the second aspect.

According to a ninth aspect, an embodiment of the present disclosure provides a computer program product. When a computer reads and executes the computer program product, the computer is enabled to perform the method in any one of the possible designs of the first aspect to the second aspect.

According to a tenth aspect, an embodiment of the present disclosure provides a computer program. When a computer reads and executes the computer program, the computer is enabled to perform the method in any one of the possible designs of the first aspect to the second aspect.

According to an eleventh aspect, an embodiment of the present disclosure provides a system comprising at least one of an apparatus in (or at) an access point (AP) of the present disclosure, or an apparatus in (or at) a non-AP device of the present disclosure.

According to a twelfth aspect, an embodiment of the present disclosure provides a method performed by a system comprising at least one of an apparatus in (or at) an access point (AP) of the present disclosure, and an apparatus in (or at) a non-AP device of the present disclosure.

This application encompasses various embodiments, including not only method embodiments, but also other embodiments such as apparatus embodiments and embodiments related to non-transitory computer readable storage media. Embodiments may incorporate, individually or in combinations, the features disclosed herein.

A wireless communication method and related apparatus are provided by the present disclosure. A frame carrying the indication information for TB A-PPDU combinations can be transmitted. By defining a reserved combination of the first field and the second field (e.g., the UL BW subfield and the UL BW Extension subfield) to indicate the channel for transmission of different types of PPDUs in the TB A-PPDU, it can support a wider range of TB A-PPDU combinations.

### BRIEF DESCRIPTION OF THE DRAWINGS

The accompanying drawings are used to provide a further understanding of the present disclosure, constitute a part of the specification, and are used to explain the present disclosure together with the following specific embodiments, but should not be construed as limiting the present disclosure.

FIG. 1A is a schematic illustration of a network for communicating data according to one or more embodiments of the present disclosure.

FIG. 1B is a schematic illustration of an apparatus wirelessly communicating with another apparatus within a communication system according to one or more embodiments of the present disclosure.

FIG. 2 is a schematic illustration of a trigger frame format according to one or more embodiments of the present disclosure.

FIG. 3A is a schematic illustration of the HE variant Common Info field format according to one or more embodiments of the present disclosure.

FIG. 3B is a schematic illustration of the EHT variant Common Info field format according to one or more embodiments of the present disclosure.

FIG. 4A is a schematic illustration of the HE variant User Info field format according to one or more embodiments of the present disclosure.

FIG. 4B is a schematic illustration of the EHT variant User Info field format according to one or more embodiments of the present disclosure.

FIG. 4C is a schematic illustration of the Special User Info field format according to one or more embodiments of the present disclosure.

FIG. 5 is a schematic illustration of possible UHR combinations for TB A-PPDU according to one or more embodiments of the present disclosure.

FIG. 6 is a schematic illustration of the parameters associated with the Special User Info field according to one or more embodiments of the present disclosure.

FIG. 7 is a schematic illustration of the UHR variant Common Info field format according to one or more embodiments of the present disclosure.

FIG. 8A is a schematic illustration of interaction between nodes in a communication system according to one or more embodiments of the present disclosure.

FIG. 8B is a schematic illustration of a frame format according to one or more embodiments of the present disclosure.

FIG. 9A is a schematic illustration of the parameters associated with the Special User Info field in mode (1) according to one or more embodiments of the present disclosure.

FIG. 9B is a schematic illustration of the parameters associated with TB A-PPDU signaling in mode (1) according to one or more embodiments of the present disclosure.

FIG. 9C is a schematic illustration of the format of the TB A-PPDU in mode (1) according to one or more embodiments of the present disclosure.

FIG. 10A is another schematic illustration of the parameters associated with the Special User Info field in mode (1) according to one or more embodiments of the present disclosure.

FIG. 10B is another schematic illustration of the parameters associated with TB A-PPDU signaling in mode (1) according to one or more embodiments of the present disclosure.

FIG. 10C is another schematic illustration of the format of the TB A-PPDU in mode (1) according to one or more embodiments of the present disclosure.

FIGS. 11A-11B are schematic illustrations of the parameters associated with the Special User Info fields in mode (2) according to one or more embodiments of the present disclosure.

FIG. 11C is a schematic illustration of the parameters associated with TB A-PPDU signaling in mode (2) according to one or more embodiments of the present disclosure.

FIG. 11D is a schematic illustration of the format of the TB A-PPDU in mode (2) according to one or more embodiments of the present disclosure.

FIG. 12A is a schematic illustration of the parameters associated with the Special User Info field in mode (a) according to one or more embodiments of the present disclosure.

FIG. 12B is a schematic illustration of the parameters associated with TB A-PPDU signaling in mode (a) according to one or more embodiments of the present disclosure.

FIG. 12C is a schematic illustration of the format of the TB A-PPDU in mode (a) according to one or more embodiments of the present disclosure.

FIGS. 13A-13B are schematic illustrations of the parameters associated with the Special User Info fields in mode (b) according to one or more embodiments of the present disclosure.

FIG. 13C is a schematic illustration of the parameters associated with TB A-PPDU signaling in mode (b) according to one or more embodiments of the present disclosure.

FIG. 13D is a schematic illustration of the format of the TB A-PPDU in mode (b) according to one or more embodiments of the present disclosure.

FIG. 14A is a schematic illustration of the parameters associated with the Special User Info field in mode (c) according to one or more embodiments of the present disclosure.

FIG. 14B is a schematic illustration of the parameters associated with TB A-PPDU signaling in mode (c) according to one or more embodiments of the present disclosure.

FIG. 14C is a schematic illustration of the format of the TB A-PPDU in mode (c) according to one or more embodiments of the present disclosure.

FIGS. 15A-15B are schematic illustrations of the parameters associated with the Special User Info fields in mode (d) according to one or more embodiments of the present disclosure.

FIG. 15C is a schematic illustration of the parameters associated with TB A-PPDU signaling in mode (d) according to one or more embodiments of the present disclosure.

FIG. 15D is a schematic illustration of the format of the TB A-PPDU in mode (d) according to one or more embodiments of the present disclosure.

FIGS. 16A-16B are schematic illustrations of the parameters associated with the Special User Info fields in mode (d) according to one or more embodiments of the present disclosure.

FIG. 16C is another schematic illustration of the parameters associated with TB A-PPDU signaling in mode (d) according to one or more embodiments of the present disclosure.

FIG. 16D is another schematic illustration of the format of the TB A-PPDU in mode (d) according to one or more embodiments of the present disclosure.

FIGS. 17A-17C are schematic illustrations of the parameters associated with the Special User Info fields in mode (e) according to one or more embodiments of the present disclosure.

FIG. 17D is a schematic illustration of the parameters associated with TB A-PPDU signaling in mode (e) according to one or more embodiments of the present disclosure.

FIG. 17E is a schematic illustration of the format of the TB A-PPDU in mode (e) according to one or more embodiments of the present disclosure.

FIGS. 18A-18B are schematic illustrations of the parameters associated with the Special User Info fields in mode (f) according to one or more embodiments of the present disclosure.

FIG. 18C is a schematic illustration of the parameters associated with TB A-PPDU signaling in mode (f) according to one or more embodiments of the present disclosure.

FIG. 18D is a schematic illustration of the format of the TB A-PPDU in mode (f) according to one or more embodiments of the present disclosure.

FIGS. 19A-19B are schematic illustrations of the parameters associated with the Special User Info fields in mode (f) according to one or more embodiments of the present disclosure.

FIG. 19C is another schematic illustration of the parameters associated with TB A-PPDU signaling in mode (f) according to one or more embodiments of the present disclosure.

FIG. 19D is another schematic illustration of the format of the TB A-PPDU in mode (f) according to one or more embodiments of the present disclosure.

FIG. 20 is a schematic structural diagram of an apparatus according to one or more embodiments of the present disclosure.

FIG. 21 is a block diagram of an apparatus according to one or more embodiments of the present disclosure.

FIG. 22 is a block diagram of a wireless communication apparatus according to one or more embodiments of the present disclosure.

### DETAILED DESCRIPTION

In the following description, reference is made to the accompanying figures, which form part of the present disclosure, and which show, by way of illustration, specific aspects of embodiments of the present disclosure or specific aspects in which embodiments of the present disclosure may be used. It is understood that embodiments of the present disclosure may be used in other aspects and include structural or logical changes not depicted in the figures. The following detailed description, therefore, is not to be taken in a limiting sense, and the scope of the present disclosure is defined by the appended claims.

The technical solutions in embodiments of the present disclosure may be applied to a wireless local area network (WLAN) system, or may be applied to a communication system of another standard, e.g., a long-term evolution (LTE) system, or other future communication systems. A station (STA) and an access point (AP) are basic components of the WLAN system. The AP is an access point used by a mobile user to access a wired network, and is mainly deployed within a home, a building, and a campus, with a typical coverage radius of a few dozen meters to a few hundred meters. Certainly, the AP may also be deployed outdoors. The AP is equivalent to a bridge that connects the wired network and a wireless network. A main function of the AP is to connect wireless network clients together, and then connect the wireless network to the Ethernet. Specifically, the AP may be an apparatus with a Wi-Fi (Wireless Fidelity) chip, e.g., a terminal device or a network device with a Wi-Fi chip. In an example, the AP may be a device that supports the 802.11ax standard. In another example, the AP may be a device that supports a plurality of WLAN standards, such as 802.11ac, 802.11n, 802.11g, 802.11b, 802.11a, etc. Further, the AP may also be a device that supports 802.11be, 802.11bn and a WLAN standard that supports other future 802.11 standards. A standard type supported by the AP is not limited in the embodiments of the present disclosure.

The STA is generally a terminal device in a WLAN system. The STA may be movable or may be fixed, and is a basic component of a wireless communication chip, a wireless sensor, or a wireless communication terminal, such as a mobile phone supporting a Wi-Fi communication function, a set-top box supporting a Wi-Fi communication function, a smart television supporting a Wi-Fi communication function, a smart wearable device supporting a Wi-Fi communication function, an in-vehicle communication device supporting a Wi-Fi communication function, or a computer supporting a Wi-Fi communication function, etc. Similarly, the STA may be a device that supports the 802.11ax standard, or the STA may be a device that supports a plurality of WLAN standards, such as 802.11ac, 802.11n, 802.11g, 802.11b, 802.11a, etc. Further, the STA may also be a device that supports 802.11be, 802.11bn, and a WLAN standard that supports other future 802.11 standards. A standard type supported by the STA is not limited in the embodiments of the present disclosure.

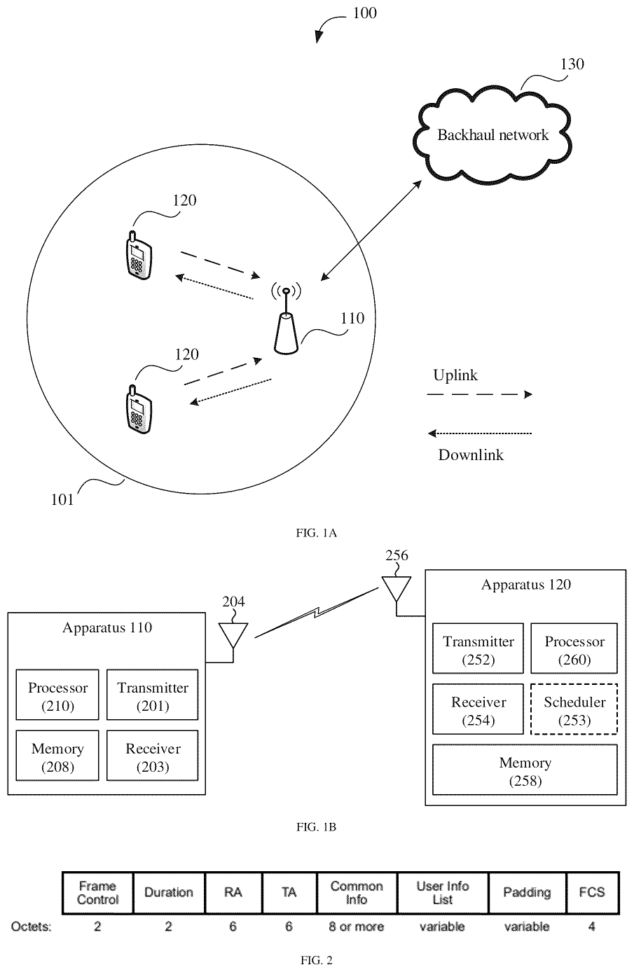

FIG. 1A is a schematic illustration of a network 100 for communicating data. The network 100 includes an access point (AP) 110 having a coverage area 101, a plurality of mobile devices 120, and a backhaul network 130. As shown in FIG. 1A, the AP 110 establishes uplink (dashed line) and/or downlink (dotted line) connections with the mobile devices 120, which serve to carry data from the mobile devices 120 to the AP 110 and vice-versa. Data carried over the uplink/downlink connections may include data communicated between the mobile devices 120, as well as data communicated to/from a remote-end (not shown) by way of the backhaul network 130. As used herein, the term “access point” refers to any component (or collection of components) configured to provide wireless access in a network, such as an evolved NodeB (eNB), a macro-cell, a femtocell, a Wi-Fi AP, or other wirelessly enabled devices. APs may provide wireless access in accordance with one or more wireless communication protocols, e.g., Long Term Evolution (LTE), LTE advanced (LTE-A), High Speed Packet Access (HSPA), Wi-Fi 802.11a/b/g/n/ac, etc. As used herein, the term “mobile device” refers to any component (or collection of components) capable of establishing a wireless connection with an access point, such as user equipment (UE), a mobile station (STA), and other wirelessly enabled devices. In some embodiments, the network 100 may include various other wireless devices, such as relays, low power nodes, etc.

FIG. 1B is a schematic illustration showing an apparatus 110 wirelessly communicating with another apparatus 120 within a communication system (e.g., the WLAN system) according to an implementation of the present disclosure. The apparatus 110 may be a receiving end (e.g., STA), or the apparatus 120 may be a transmitting end (e.g., AP). Although only one apparatus 110, and one apparatus 120, are shown in the figure, the number of apparatus 110 and/or number of apparatus 120 can vary, potentially including one or more of each.

The apparatus 110 may include one or more processors 210. For clarity and to avoid overcrowding the illustration, only a single processor 210 is illustrated. The apparatus 110 may further include a transmitter 201 and a receiver 203 coupled to one or more antennas 204. For clarity, only a single antenna 204 is illustrated. One, some, or all of the antennas 204 may alternatively be panels. In some implementations, the transmitter 201 and the receiver 203 are separate from each other. In other implementations, the transmitter 201 and the receiver 203 may be integrated into a single unit, for example, as a transceiver. The transceiver is configured to modulate data or other content for transmission by the one or more antennas 204 or a network interface controller (NIC). The transceiver may also be configured to demodulate data or other content received by the one or more antennas 204. A transceiver may include any suitable structure for generating signals for wireless or wired transmission and/or for processing signals received through wireless or wired communication. Each antenna 204 includes any suitable structure for transmitting and/or receiving wireless or wired signals. The apparatus 110 may include a memory 208. In some implementations, the apparatus 110 may include multiple memories 208. Only a single transmitter 201, receiver 203, processor 210, memory 208, and antenna 204 is illustrated for simplicity, but the apparatus 110 may include one or more other components. In some implementations of the present disclosure, the transceiver (or transmitter 201 and/or receiver 203) may be viewed as an interface circuit.

The memory 208 is configured to store instructions used to perform operations described herein. The memory 208 may also be configured to store data that is used, generated, or collected by the apparatus 110. For example, the memory 208 can store software instructions or modules configured to implement some or all of the functionalities and/or operations described herein and that which are executed by the one or more processors 210.

The apparatus 110 may further include one or more input/output devices (not shown) or interfaces. The input/output devices or interfaces facilitate interaction with a user or other devices in the network. Each input/output device or interface includes suitable components for facilitating transmission of information to a user and reception of information from a user, and for various network interface communications. Such components may include, but are not limited to, a speaker, microphone, keypad, keyboard, display, touch screen, and the like.

The processor 210 may be configured to perform (or control the apparatus 110 to perform) operations (or methods) described herein as being performed by the apparatus 110. For example, the processor 210 performs or controls the apparatus 110 to perform the operations of: a) receiving one or more transport blocks (TBs), b) using a resource for decoding at least one of the received TBs, c) releasing the resource for decoding another of the received TBs, and/or d) receiving configuration information configuring a resource. Specifically, the operations may include tasks related to: preparing a transmission for UL transmission to the apparatus 120, processing DL transmissions received from the apparatus 120, and handling SL transmission to and from another apparatus 110. Processing operations related to preparing a transmission for UL transmission may include operations such as, but not limited to, encoding, modulating, transmit beamforming, and generating symbols for transmission. Processing operations related to processing DL transmissions may include operations such as, but not limited to, receive beamforming, demodulating and decoding received symbols. Processing operations related to processing SL transmissions may include operations such as, but not limited to, transmit/receive beamforming, modulating/demodulating and encoding/decoding symbols. Depending upon the implementation, a DL transmission may be received by the receiver 203, possibly using receive beamforming, and the processor 210 may extract signaling from the DL transmission (such as by detecting and/or decoding the signaling). An example of signaling may be a reference signal transmitted by the apparatus 120. In some implementations, the processor 210 implements the transmit beamforming and/or the receive beamforming based on the indication of beam direction, such as beam angle information (BAI), received from the apparatus 120. In some implementations, the processor 210 may be configured to perform operations relating to network access (such as initial access) and/or downlink synchronization, which includes operations for detecting a synchronization sequence, decoding and obtaining the system information, and the like. In some implementations, the processor 210 may perform channel estimation, such as using a reference signal received from the apparatus 120.

Although not illustrated, in some implementations, the processor 210 may either be a part of the transmitter 201 or a part of the receiver 203 or a part of both the transmitter 201 and the receiver 203. Although not illustrated, in some implementations, the memory 208 may be a part of the processor 210.

The processor 210, along with the processing components of the transmitter 201 and the receiver 203 may each be implemented by one or more processors that may the same or different. These processors are configured to execute instructions stored in a memory (such as in the memory 208).

The apparatus 120 includes one or more processors 260 (only one processor 260 is illustrated). The apparatus 120 may further include one or more transmitters 252 and one or more receivers 254 coupled to one or more antennas 256. Only a single antenna 256 is illustrated to avoid clutter in the illustration. One, some, or all of the antennas 256 may alternatively be panels. In some implementations, the transmitter 252 and the receiver 254 are separate from each other. In other implementations, the transmitter 252 and the receiver 254 may be integrated into a single unit such as, for example, as a transceiver. The apparatus 120 may further include a memory 258. In some implementations, the apparatus 120 may include multiple memories 258. The apparatus 120 may further include a scheduler 253. Only a single transmitter 252, receiver 254, processor 260, memory 258, antenna 256 and scheduler 253 are illustrated for simplicity, however the apparatus 120 may include one or more other components. In the present disclosure, in some implementations, the transceiver (or transmitter 252 and/or receiver 254) may be viewed as an interface circuit.

In some implementations, various components of the apparatus 120 may be distributed. For example, some of the modules of the apparatus 120 may be located remotely from the equipment housing the antennas 256 for the apparatus 120 (and therefore also can be viewed as one or more nodes). These modules, which can be considered as one or more nodes, may be coupled to the equipment that houses the antennas 256 over a communication link (not shown), sometimes referred to as front haul, such as the Common Public Radio Interface (CPRI). Therefore, in some implementations, the term apparatus 120 may also refer to network-side nodes that perform processing operations such as, but not limited to, determining the location of the apparatus 110, resource allocation (scheduling), message generation, and encoding/decoding, and that which are not necessarily part of the equipment that houses the antennas 256 of the apparatus 120. The nodes may also be coupled to other apparatuses 120. In some implementations, the apparatus 120 may actually be a plurality of nodes that are operating together to serve the apparatus 110, such as through the use of coordinated multipoint transmissions, or through the use of an open radio access network (ORAN) system.

The processor 260 is configured to perform operations including those related to: preparing a transmission for DL transmission to the apparatus 110, processing a UL transmission received from the apparatus 110, preparing a transmission for backhaul transmission to another apparatus 120, and processing a transmission received over backhaul from another apparatus 120. Processing operations related to preparing a transmission for DL or backhaul transmission may include operations such as, but not limited to, encoding, modulating, precoding (such as MIMO precoding), transmit beamforming, and generating symbols for transmission. Processing operations related to processing received transmissions in the UL or over backhaul may include operations such as, but not limited to, receive beamforming, demodulating received symbols, and decoding received symbols. The processor 260 may also be configured to perform operations relating to network access (such as initial access) and/or DL synchronization, such as generating the content of synchronization signal blocks (SSBs), generating the system information, and the like. In some implementations, the processor 260 is further configured to generate an indication of beam direction, such as BAI, which may be scheduled for transmission by the scheduler 253 which will be described below. In some implementations, the processor 260 implements the transmit beamforming and/or receive beamforming based on beam direction information (such as BAI) received from another apparatus 120. The processor 260 is configured to perform other network side processing operations described herein, such as, but not limited to, determining the location of the apparatus 110, determining where to deploy another apparatus 120, and the like. In some implementations, the processor 260 may generate signaling data, to configure one or more parameters of the apparatus 110 and/or one or more parameters of another apparatus 120. Any signaling data generated by the processor 260 is sent by the transmitter 252. In some implementations, the apparatus 120 implements physical layer processing. In some implementations, the apparatus 120 may perform higher layer functions such as those at the Medium Access Control (MAC) or Radio Link Control (RLC) layers in addition to physical layer processing. In the apparatus 120, the scheduler 253 may be coupled to the processor 260 or integrated within the processor 260. In some implementations, the scheduler 253 may be integrated within the apparatus 120 or may be operated separately from the apparatus 120. The scheduler 253 may schedule UL, DL, SL, and/or backhaul transmissions, including issuing scheduling grants and/or configuring scheduling-free (such as “configured grant”) resources. Note that the term “signaling”, as used herein, may alternatively be referred to as control signaling, control message, control information, or message for simplicity.

The apparatus 120 may further include a memory 258 that is configured to store instructions for performing the operations described herein. The memory 258 may also store data that is used, generated, or collected by the apparatus 120. For example, the memory 258 can store software instructions or modules configured to implement some or all of the functionalities and/or implementations described herein and that which are executed by the processor 260.

Although not illustrated, the processor 260 may be implemented as part of the transmitter 252 and/or a part of the receiver 254. Although not illustrated, in some implementations, the processor 260 may implement the scheduler 253 and the memory 258 may be implemented as part of the processor 260.

The processor 260, the scheduler 253, the processing components of the transmitter 252, and the processing components of the receiver 254 may each be implemented by the same or different processors that are configured to execute instructions stored in a memory, such as in the memory 258. The apparatus 120 and/or the apparatus 110 may include other components, not shown or described herein for the sake of clarity.

It should be noted that in the present disclosure, “information”, when different from “message”, may be carried within a single message, or may be carried in multiple separate messages.

Since different generations of STAs may have different capabilities, so before elaborating the embodiments of the present disclosure, several non-AP STA involved will be defined in the first place. Sometimes when referring to these STAs, the expression “non-AP” will be omitted for brevity.

Non-AP HE STA: a STA supporting the 802.11ax standard and any legacy generations before 802.11ax, this may also be called non-AP non-EHT HE STA.

Non-AP EHT STA: a STA supporting the 802.11be standard and any legacy generations before 802.11be, this may also be called EHT STA or non-UHR EHT STA throughout the text.

Non-AP UHR STA: a STA supporting the 802.11bn standard and any legacy generations before 802.11bn, this may also be called UHR STA for brevity throughout the text.

The EHT-STA and the UHR STA are both non-HE STAs.

A WLAN system may be taken as an example to illustrate the technical solutions in the embodiments of the present disclosure. In the WLAN system, the transmitting end (e.g., AP) may transmit a trigger frame to the receiving end (e.g., STA), and in response to the trigger frame, the STA may transmit a Trigger-based Physical Layer Protocol Data Unit (TB-PPDU) to the AP.

Trigger frames are poised to be a cornerstone of the 802.11bn standard, serving as a versatile mechanism for a wide range of advanced network operations. Numerous proposals underscore the role of trigger frames in facilitating Ultra-High Reliability (UHR) features, such as multi-AP coordination, in-device coexistence management, dynamic power saving, dynamic sub-band operation, and non-primary channel access. These enhancements are critical for the evolution of the 802.11bn standard, ensuring it can support the growing demands for Ultra-High Reliability (UHR) and adaptability in wireless LAN networks. The primary focus has been on several specific types of trigger frames, including basic trigger frame (TF), multi-user request-to-send (MU-RTS), MU-RTS transmit with schedule (TXS), Buffer Status Report Poll (BSRP), Bandwidth Query Report Poll (BQRP), and Beamforming Report Poll (BFRP). These trigger frame types are essential for the efficient functioning of various network operations.

The concept of a Trigger-based Aggregated Physical Layer Protocol Data Unit (TB A-PPDU) introduces a method for combining two or more independent and complete PPDUs into a single transmission. This aggregation allows different types of frames and PPDU formats to coexist within a unified communication. In an A-PPDU (TB A-PPDU), the combined PPDUs are fully formed, standalone transmissions that are concatenated together to optimize the overall network performance. One of the key features of the TB A-PPDU is its ability to support different PPDU formats within the same transmission. For example, one of the PPDUs could use a non-High Throughput (non-HT) PPDU format, which is common in older Wi-Fi standards (e.g., Wi-Fi 6), while the other PPDU could use a more advanced format like the Extremely High Throughput (EHT) PPDU format (in Wi-Fi 7), or the Ultra High Reliability (UHR) PPDU format (in Wi-Fi 8). This flexibility enables the A-PPDU to cater to different types of devices and transmission requirements, making it particularly useful in networks where both legacy and future-generation devices are operating simultaneously. In particular, TB A-PPDU can significantly enhance performance by taking advantage of wider bandwidth channels, even in the presence of legacy transmissions. When transmissions are aggregated across wider bandwidths, such as combining two 80 MHz PPDUs transmission into a 160 MHz channel or two 160 MHz PPDUs transmission into a 320 MHz channel, the data rate can be nearly doubled. This effect is even more pronounced when aggregating 80 MHz transmissions into a 320 MHz channel, where the data rate improvement can be close to four times the original rate. In addition to boosting data rates, the TB A-PPDU approach also reduces latency compared to scenarios where only legacy transmissions occur on the primary channel. By aggregating transmissions across wider channels, the TB A-PPDU mechanism maximizes the available bandwidth, minimizes contention, and ultimately delivers faster and more efficient communication, making it a powerful tool for enhancing the performance of modern wireless networks.

In view of the above, the TB A-PPDU mechanism offers significant benefits in terms of efficiency, flexibility, and multi-functionality. By reducing the overhead associated with multiple separate transmissions and allowing different PPDU variants to coexist, the A-PPDU optimizes network resource utilization. This makes it an essential feature in modern wireless networks, particularly in high-density environments where various types of communication coexist and operate efficiently.

Next, details about the signaling method for a combination of TB A-PPDU and possible UHR combinations for TB A-PPDU will be described.

In related art, the trigger frame format is provided, as shown in FIG. 2, the trigger frame may include the Frame Control field, the Duration field, the RA field, the TA field, the Common Info field, the User Info List field, the Padding field, and the FCS field. Regarding the representations of the aforementioned fields, reference may be made to the related art, and possible fields associated with the signaling method would be introduced below.

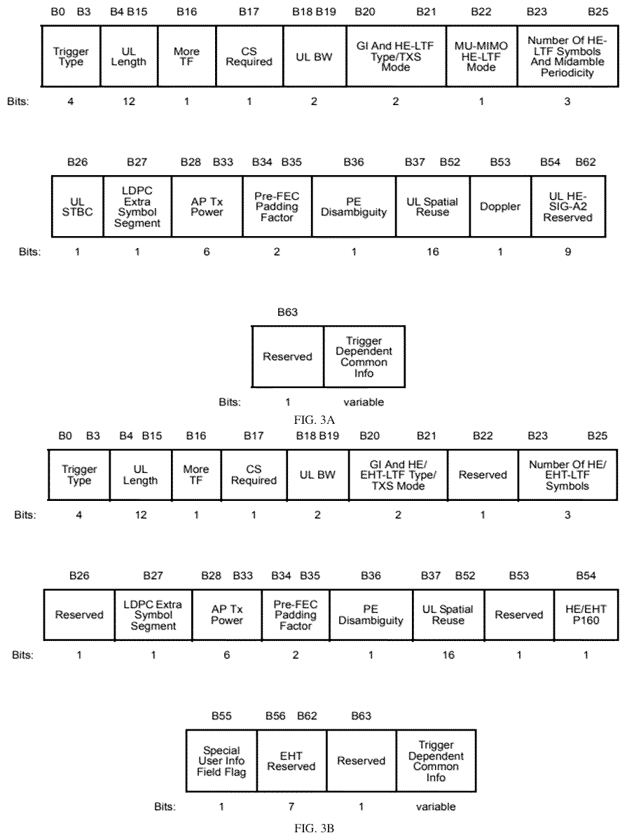

The Common Info field has two variants: High-Efficiency (HE) variant Common Info field and Extremely High Throughput (EHT) variant Common Info field. FIGS. 3A-3B are schematic illustrations of the HE variant Common Info field and the EHT variant Common Info field formats respectively. The HE variant Common Info field and the EHT variant Common Info field use the same encoding method for the Trigger Type subfield, UL Length subfield, More TF subfield, CS Required subfield, LDPC Extra Symbol Segment subfield, AP TX Power subfield, Pre-FEC Padding Factor subfield, PE Disambiguity subfield, and Trigger Dependent Common Info subfield. The key distinction between these variants lies in the repurposing of specific bits. In the EHT variant Common Info field, bits B22, B26, and B53 are kept reserved, while bits B54 and B55 are repurposed to indicate HE/EHT PPDU in primary 160 MHz channel (P160) and special user info indication, respectively. For backward compatibility with the HE variant Common Info field, an EHT AP sets B22, B26, B53, and B63 to 0 and sets B56-B62 to 1 in the EHT variant Common Info field.

The UL BW subfield of the HE variant Common Info field indicates the bandwidth in the HE-SIG-A field of the HE TB PPDU (or referred to as the HE PPDU hereinafter), and its encoding rule is defined in the following table 1.

TABLE 1

| UL BW | |
|---|---|
| subfield | |
| value | Description |
| 0 | 20 MHz |
| 1 | 40 MHz |
| 2 | 80 MHz |
| 3 | 80 + 80 MHz or 160 MHz |

The UL BW subfield of the EHT variant Common Info field along with the UL BW Extension subfield of the Special User Info field indicates the bandwidth in the U-SIG field of the EHT TB PPDU (or referred to as the EHT PPDU hereinafter). A corresponding encoding rule at this case will be described later.

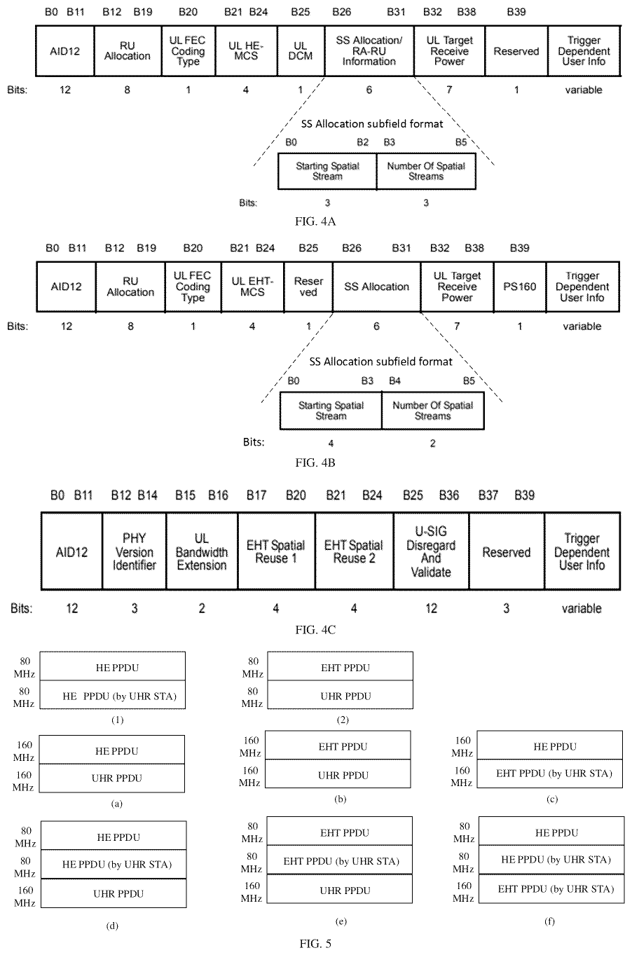

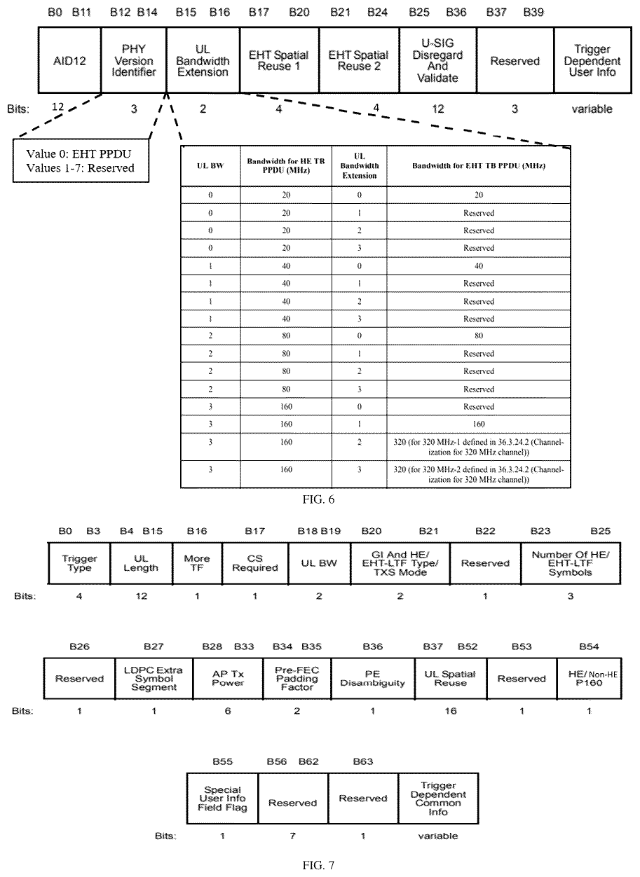

There are three variants for the User Info List field: Special User Info field, HE variant User Info field, and EHT variant User Info field. FIGS. 4A-4C are schematic illustrations of the HE variant User Info field, the EHT variant User Info field, and the Special User Info field formats respectively. All User Info fields (including the Special User Info field) in the User Info List field of a Trigger frame have the same length unless the Trigger frame is an MU-BAR (Multi-user block ack request) Trigger frame. A User Info field that is addressed to a non-AP STA is either a HE variant User Info field or an EHT variant User Info field. The User Info field is a HE variant User Info field addressed to a non-AP EHT STA if Bit 39 (B39) of the User Info field is set to 0 and Bit 54 (B54) of the Common Info field is set to 1 in the Trigger frame; otherwise, it is an EHT variant User Info field. B39 of a HE variant User Info field is reserved for a non-EHT HE STA. B39 is set to 0 for a HE variant User Info field by an EHT AP (an AP supporting the 802.11be standard), and is the PS160 subfield for an EHT variant User Info field.

The Special User Info field is a User Info field that does not carry user specific information but carries extended common information not provided in the Common Info field. The Special User Info field is identified by an AID12 value of 2007 and is optionally present in a Trigger frame that is generated by an EHT AP. An EHT AP does not use the value 2007 as an AID for any STA associated to it. The Special User Info field is not included in the Trigger frame unless the Trigger frame includes one or more EHT variant User Info fields. The Special User Info field, if present, is located immediately after the Common Info field of the Trigger frame and carries information for the U-SIG field of a solicited EHT TB PPDU.

The PHY Version Identifier subfield in the Special User Info field indicates the PHY version of the solicited TB PPDU that is not a HE TB PPDU. The PHY Version Identifier subfield is set to 0 for EHT PPDU, while the values from 1 to 7 are reserved.

As mentioned before, the UL Bandwidth Extension subfield in the Special User Info field, together with the UL BW subfield in the Common Info field, indicates the bandwidth of the solicited TB PPDU (i.e., the bandwidth in the U-SIG field of the EHT TB PPDU). The encoding rule of the UL Bandwidth Extension subfield is defined in the following table 2.

TABLE 2

| | Bandwidth for | UL | Bandwidth for |
|---|---|---|---|
| | HE TB PPDU | Bandwidth | EHT TB PPDU |
| UL BW | (MHz) | Extension | (MHz) |
| 0 | 20 | 0 | 20 |
| 0 | 20 | 1 | Reserved |
| 0 | 20 | 2 | Reserved |
| 0 | 20 | 3 | Reserved |
| 1 | 40 | 0 | 40 |
| 1 | 40 | 1 | Reserved |
| 1 | 40 | 2 | Reserved |
| 1 | 40 | 3 | Reserved |
| 2 | 80 | 0 | 80 |
| 2 | 80 | 1 | Reserved |
| 2 | 80 | 2 | Reserved |
| 2 | 80 | 3 | Reserved |
| 3 | 160 | 0 | Reserved |
| 3 | 160 | 1 | 160 |
| 3 | 160 | 2 | 320 (for 320 MHz-1 defined |
| | | | in 36.3.24.2 (Channelization |
| | | | for 320 MHz channel)) |
| 3 | 160 | 3 | 320 (for 320 MHz-2 defined |
| | | | in 36.3.24.2 (Channelization |
| | | | for 320 MHz channel)) |

As mentioned before, a User Info field that is addressed to a non-AP STA is either a HE variant User Info field or an EHT variant User Info field. The User Info field is a HE variant User Info field addressed to a non-AP EHT STA if B39 of the User Info field is set to 0 and B54 of the Common Info field is set to 1 in the Trigger frame; otherwise, it is an EHT variant User Info field. B39 of a HE variant User Info field is reserved for a non-EHT HE STA. B39 is set to 0 for a HE variant User Info field by an EHT AP, and is the PS160 subfield for an EHT variant User Info field. Table 3 defines valid combinations of B54 and B55 in the Common Info field, B39 in the User Info field, the presence of the Special User Info field in the Trigger frame, the variant of a User Info field, and the corresponding TB PPDU type.

TABLE 3

| Common | Common | User | Presence of | | |
|---|---|---|---|---|---|
| Info | Info | Info | Special User | User | |
| field | field | field | Info | Info field | TB PPDU |
| B54 | B55 | B39 | field | variant | type |
| 1 | 1 | 0 | No | HE variant | HE |
| 0 | 0 | 0 | Yes | EHT variant | EHT |
| 0 | 0 | 1 | Yes | EHT variant | EHT |
| 1 | 0 | 1 | Yes | EHT variant | EHT |
| 1 | 0 | 0 | Yes | HE variant | HE |

For example, if an EHT AP sends a Trigger frame that intends to solicit an EHT TB PPDU with a 4×996-tone resource unit (RU) from an EHT STA, then the AP sets B54 and B55 of the Common Info field to 0 and sets B39 to 1 in the User Info field addressed to the STA. Although the last two rows in Table 3 are not used by an EHT AP, a non-AP EHT STA might respond to a Trigger frame with B54 in the Common Info field equal to 1 and with B55 in the Common Info field equal to 0 based on the last two rows. Additionally, it is worth mentioning that in 802.11be standard, the trigger frame can support an A-PPDU of HE (TB) PPDU in a primary 160 MHz channel (P160 for short) and EHT (TB) PPDU in secondary 160 MHz channel (S160 for short) whilst the specification disallows the AP to do that.

In view of the aforementioned signaling method in 802.11 be standard, it is restricted to only one specific combination of TB A-PPDUs (a combination of HE PPDU in P160 and EHT PPDU in S160). This limits the adaptability of the system to future PPDU variants and potential other use cases. While the signaling method of TB A-PPDUs (a combination of HE PPDU in P160 and EHT PPDU in S160) is defined, the 802.11be specification disallows the AP to do that. The foregoing indication mechanism may not be easily scalable to accommodate other future or additional PPDU variants. This could hinder the ability of the system to evolve and support new or other PPDU variants. The restriction to a single combination of TB A-PPDUs might limit the system's performance in certain scenarios, especially if other combinations could offer advantages in terms of throughput, latency, or power efficiency.

Assuming UHR STA will support TB A-PPDU, several possible UHR combinations for TB A-PPDU are proposed, as shown in FIG. 5. Some introductions about the proposed UHR combinations for TB A-PPDU will be given below. It should be noted that in FIG. 5, unless emphasizing the STA from which the PPDU is solicited, the generation of the STA transmitting the solicited PPDU corresponds to the name of the solicited PPDU. For example, HE PPDU is requested to be transmitted from a HE STA, EHT PPDU is requested to be transmitted from an EHT STA, HE PPDU (by UHR STA) is requested to be transmitted from a UHR STA.

When the aggregated bandwidth is 160 MHz, as shown in (1) and (2) of FIG. 5, there may be a combination of 80 MHz HE PPDU+80 MHz HE PPDU (by UHR STA) or 80 MHz EHT PPDU+80 MHz UHR PPDU. As it is optional for non-EHT HE STA to support large bandwidth Orthogonal Frequency Division Multiple Access (OFDMA), hence mode (1) enhances maximum bandwidth from 80 MHz to 160 MHz, twice throughput gain, when there exists 80 MHz capable only non-EHT HE STA. The TB A-PPDU is a combination of two HE PPDUs, one is to be transmitted by a HE STA while another is to be transmitted by a UHR STA. Mode (2) is beneficial if some potential UHR feature makes UHR PPDU better than EHT PPDU in A-PPDU scenario.

There may be other combinations of PPDUs for the case of bandwidth 160 MHz, e.g., when dividing a primary 160 MHz channel into two 80 MHz channels, we may obtain a primary 80 MHz channel (P80 for short) and a secondary 80 MHz channel (S80 for short), then a combination of 80 MHz HE PPDU+80 MHz EHT/UHR PPDU, a combination of 80 MHz EHT PPDU+80 MHz EHT PPDU or 80 MHz UHR PPDU+80 MHz UHR PPDU may be possible. The combination of 80 MHz HE PPDU+80 MHz EHT/UHR PPDU makes L-length in different 80 MHz different, so if combined reception is done for 80 MHz, these combinations may be also possible, but if combined reception is done for 160 MHz, L-SIG reception error may happen. HE-SIG-A difference in different 80 MHz may lead to HE-SIG-A reception error. Regarding the combination of a 160 MHz EHT PPDU or a 160 MHz UHR PPDU and the combination of 80 MHz EHT PPDU+80 MHz EHT PPDU or 80 MHz UHR PPDU+80 MHz UHR PPDU rival each other in performance.

Assuming the maximum bandwidth for UHR is 320 MHz, there may be the following possible 160 MHz (P160)+160 MHz (S160) combinations of PPDUs. As shown in (a) of FIG. 5, it illustrates a combination of 160 MHz HE PPDU+160 MHz UHR PPDU. Mode (a) enhances maximum bandwidth from 160 MHz to 320 MHz, twice throughput gain. As shown in (b) of FIG. 5, it illustrates a combination of 160 MHz EHT PPDU+160 MHz UHR PPDU. Mode (b) is beneficial if some potential UHR feature (e.g., unequal modulation (UEQM), higher coding rate) makes UHR PPDU better than EHT PPDU. As shown in (c) of FIG. 5, it illustrates a combination of 160 MHz HE PPDU (by a HE STA)+160 MHz EHT PPDU (by a UHR STA). Compared with mode (a), mode (c) is beneficial if some non-UHR EHT STA can transmit EHT (TB) PPDU in S160 according to 802.11be specification. Regarding the combination of a 320 MHz EHT PPDU or a 320 MHz UHR PPDU and the combination of 160 MHz+160 MHz modes including HE PPDU+HE PPDU, EHT PPDU+EHT PPDU, UHR PPDU+UHR PPDU rival each other in performance.

Assuming the maximum bandwidth for UHR is 320 MHz, there may be the following possible 80 MHz (P80)+80 MHz (S80)+160 MHz (S160) combinations of PPDUs, here the P80 and S80 would be from a division of a primary 160 MHz channel. As shown in (d) of FIG. 5, it illustrates a combination of 80 MHz HE PPDU+80 MHz HE PPDU (by UHR STA)+160 MHz UHR PPDU. Mode (d) enhances maximum bandwidth from 80 MHz to 320 MHz, Four times throughput gain. As shown in (e) of FIG. 5, it illustrates a combination of 80 MHz EHT PPDU+80 MHz EHT PPDU (by UHR STA)+160 MHz UHR PPDU. Mode (e) and mode (b) rival each other in performance. As shown in (f) of FIG. 5, it illustrates a combination of 80 MHz HE PPDU+80 MHz HE PPDU (by UHR STA)+160 MHz EHT PPDU (by UHR STA). Compared with mode (d), mode (f) is beneficial if some non-UHR EHT STA can transmit EHT (TB) PPDU in S160 according to 802.11be specification. Other 80 MHz+80 MHz+160 MHz modes, and other 80 MHz*4 modes may also be possible.

A method is proposed for signaling of the combination HE PPDU in P160 and UHR PPDU in S160. However, such method cannot not be directly applicable to other bandwidth combinations of PPDUs, such as all other aforementioned modes.

Therefore, a signaling method is desirable to cover all possible combinations which can be applicable in more scenarios and meet different requirements. To address at least one of the aforementioned technical challenges or limitations, embodiments of the present disclosure propose a generalized signaling method for TB A-PPDUs in 802.11bn standard or other future standards, and the signaling method can accommodate a wider range of TB A-PPDU combinations, ensuring greater flexibility, scalability, and potential performance benefits. The proposed signaling method can be applicable to UHR APs and STAs (APs and STAs supporting the 802.11bn standard) or devices supporting future standards.

To aggregate any x-variant PPDUs (except HE PPDU by HE STA), a Special User Info field is required to precede the x-variant User Info field. As shown in FIG. 6, within the Special User Info field, reserved values of the PHY Version Identifier subfield can be utilized to define the variant type (x-variant PPDU), and reserved values of the UL Bandwidth Extension subfield can be utilized to support TB A-PPDUs with different uplink (UL) bandwidths.

The proposed signaling method provides a unified approach for all possible TB A-PPDU UHR combinations (the aforementioned UHR combinations for TB A-PPDU, e.g., modes (1)-(2) and (a)-(f)), addressing the limitations of the restricted signaling method. The Special User Info Field is updated, and the utilization of the reserved values within the Special User Info field allows for flexible and efficient aggregation of x-variant PPDUs with HE PPDUs. Reserved values in PHY Version Identifier and UL Bandwidth Extension subfields are repurposed to define the variant type and support different UL bandwidths. The generalized signaling method enhances the system's adaptability to future PPDU variants and improves its flexibility and scalability.

A versatile and efficient signaling solution for all possible TB A-PPDU UHR combinations in 802.11bn standard will be described as an example in embodiments of the present disclosure. As mentioned before, the Special User Info field will be updated. In addition, the Common Info field format will also be updated, and FIG. 7 is a schematic illustration of the UHR variant Common Info field format. B54 is set to 1 to indicate HE (TB) PPDU in P160, with uplink bandwidth specified in the UL BW subfield in the Common Info field, and B54 is set to 0 to indicate non-HE (TB) PPDU in P160. B55 is set to 0 to indicate presence of Special User Info field, which indicates non-HE (TB) PPDU exists, with its type identified in the PHY Version Identifier subfield within the Special User Info field. Then in User Info field, B39 is set to 0 to indicate P160, B39 is set to 1 to indicate S160. Consequently, B54 is no longer exclusively reserved for HE/EHT combinations, it can be used for all other potential combinations between HE PPDU and other variants. It should be noted that specific values for bits are just illustrative rather than restrictive, other values may be also possible as long as the purposing of the specified bit is satisfied.

The above describes technical concepts of the present disclosure, and then specific embodiments about the generalized signaling for the aforementioned possible TB A-PPDU UHR combinations will be elaborated in the following.

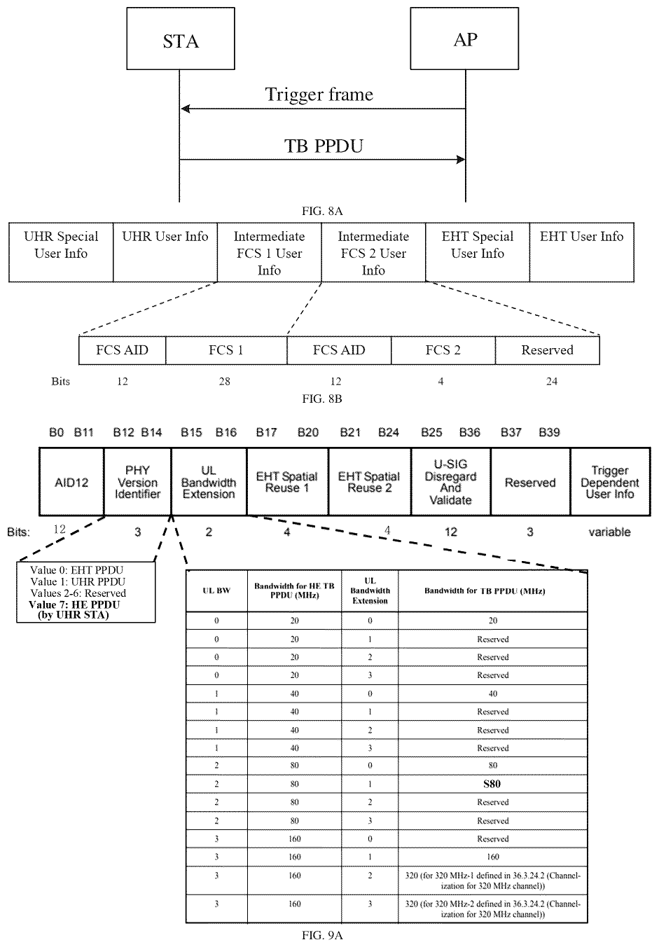

FIG. 8A is a schematic illustration of interaction between nodes in a communication system according to one or more embodiments of the present disclosure. In an example, the AP in the WLAN system may transmit a trigger frame to the STA(s) in the WLAN system, and one or more STA(S) may transmit a TB PPDU to the AP in response to the trigger frame. In the following, the solution from the perspective of the AP and the STA respectively will be introduced.

In a possible implementation, the AP may transmit a frame to one or more STAs. The frame is used for requesting transmission of plural physical layer (PHY) protocol data units (PPDU), and the frame includes a first field indicating bandwidth information for the transmission of the plural PPDUs and a second field indicating bandwidth extended information for transmission of at least one of the plural PPDUs; where a channel for the transmission of the at least one of the plural PPDUs is indicated through a reserved combination of the first field and the second field. Each of the plural PPDUs may be a PPDU from a STA supporting the 802.11ax standard, a PPDU from a STA supporting 802.11 be standard, or a PPDU from a STA supporting the 802.11bn standard or any legacy or next-generation standards. It should be noted that the frame transmitted from the AP to STA(s) may be referred to as a trigger frame, a request frame or the like, which is not limited in the embodiments of the present disclosure.

In a possible implementation, after receiving the solicited PPDUs from the STAs, the AP would process the solicited PPDUs.

In a possible implementation, the plural PPDUs may be constituent PPDUs of a TB A-PPDU, it may include more than two constituent PPDUs (more than two PPDUs for brevity). The above-mentioned at least one PPDU is requested to be transmitted on a secondary channel, and the plural PPDUs include a PPDU requested to be transmitted on a primary channel and the at least one PPDU. Here the primary channel may be P80 within P160 or P160 as described above, and the secondary channel may be a S80 within P160 or S160 as described above. The at least one of the plural PPDUs could be PPDU(s) requested to be transmitted on secondary channel(s), and may include one or more PPDUs, which is not limited in the embodiments of the present disclosure. When the at least one of the plural PPDUs includes more than one PPDU, it is possible that for each of the at least one of the plural PPDUs, the channel for transmission of this PPDU is indicated by a reserved combination of the first field and the second field.

In some implementations, the first field may be an uplink (UL) Bandwidth field in the frame, and the second field is an UL Bandwidth Extension subfield corresponding to the at least one of the plural PPDUs. Here when a bit takes a reserved value, that means that the STA will still read the bit, but will not take any action based on that bit, in different generations, the term “reserved” throughout the text may be termed in other ways, e.g., “disregarded”, etc., which is not limited in the embodiments of the present disclosure.

The frame may be a trigger frame, correspondingly, the first field may be the UL BW subfield in Common Info field of the trigger frame, and the second field may be the UL BW Extension subfield in the Special User Info field of the trigger frame. In some cases, a channel for the transmission of some PPDU(s) can be indicated by the UL BW subfield in the Common Info field. In some cases, a channel for the transmission of some PPDU(s) (one or more PPDUs among the at least one of the plural PPDUs) can be indicated by the UL BW subfield in the Common Info field together with the UL Bandwidth Extension subfield in the Special User Info field. The indication for the TB A-PPDU UHR combinations may include the channel indication and the PPDU type indication, specific implementations will be described later.

The AP transmits the frame carrying the indication information for TB A-PPDU UHR combinations, and then the STA(s) can transmit the required TB PPDU(s) to the AP in response to the received frame. By defining a reserved combination of the first field and the second field (e.g., the UL BW subfield and the UL BW Extension subfield) to indicate the channel for transmission of different types of PPDUs in the TB A-PPDU, it can support a wider range of TB A-PPDU for potential UHR combinations, so different combinations can be chosen to meet different requirements in different application scenarios, the flexibility of the system can thus be improved. Based on the unified signaling method, triggering of one or more lower generation PPDUs and one or more higher generation PPDUs from same or different generations of STAs can be achieved. The signaling method can accommodate a wider range of TB A-PPDU combinations, ensuring greater flexibility, scalability, and potential performance benefits. The proposed signaling method can be applicable to UHR APs and STAs (APs and STAs supporting the 802.11bn standard) or devices supporting future standards.

Regarding the channel indication for the plural PPDUs constituting the TB A-PPDU, the channel indication of the one PPDU requested to be transmitted on the primary channel may be achieved based on a third field. In a possible implementation, the frame further includes a third field indicates whether a high efficiency (HE) PPDU from a HE station (STA) or a non-HE PPDU from a non-HE STA is requested to be present on a primary 160 MHz channel. It should be noted that the third field here simply indicates the presence of HE PPDU or non-HE PPDU on a primary 160 MHz channel, they may be present in a certain area of P160. For example, as described above, when P160 is divided into P80+S80, it is possible that the HE PPDU or non-HE PPDU is present in P80 within P160. The third field may be Bit 54 (B54) of the Common Info field, e.g., as shown in FIG. 7 for UHR variant Common Info field format. The PPDU from a non-AP HE STA may refer to a HE PPDU, and the non-HE PPDU may refer to other PPDUs except the HE PPDU, e.g., a HE PPDU from an EHT STA or a UHR STA, an EHT PPDU from an EHT STA or a UHR STA, a UHR PPDU from a UHR STA, etc. B54 is repurposed to indicate the PPDU (a HE PPDU or a non-HE PPDU) in P160, as shown in FIG. 7. For example, the HE PPDU in P160 may be indicated by setting B54=1, and the non-HE PPDU in P160 may be indicated by setting B54-0. In addition, B54 together with the UL BW subfield in the Common Info field can be used to indicate the transmission of the PPDU in more details, e.g., if P160 is further divided into two 80 MHz channels, e.g., P80 and S80, then UL BW subfield can be used to further locate P80 within P160.

In some cases, the channel indication and the PPDU type indication can be implemented by setting the bits in the Common Info field. In a possible implementation, the plural PPDUs include the at least one of the plural PPDUs and the HE PPDU, and the third field indicates that the HE PPDU is present on the primary 160 MHz channel; where a channel for transmission of the HE PPDU by a non-AP HE STA is a primary 80 MHz channel within the primary 160 MHz channel (which means the HE PPDU is in P80 of P160), and this specific location of the HE PPDU within P160 is indicated by the first field. In this case, the TB A-PPDU may consist of the HE PPDU in the primary channel and one or more PPDUs in the secondary channel(s). As mentioned before, the first field may be the UL BW subfield in Common Info field. In an example, within the Common Info field, B54=1 and UL BW=2 may indicate the HE PPDU in P80; B54=1 and UL BW=3 may indicate the HE PPDU in P160 (which means its transmission channel is P160). For the case of HE PPDU in P80, while the third field indicates the presence of the HE PPDU in P160, the first field can be further used to further locate P80 in P160. It should be noted that for the case of HE PPDU in P160, the third field per se would be enough for indicating the channel on which the requested PPDU should be present, in this case, the first field can be set according to protocol for confirmation purpose, thereby improving the accuracy of bandwidth indication for the solicited PPDU.

In a possible implementation, the plural PPDUs include the at least one of the plural PPDUs and the non-HE PPDU requested to be transmitted from a non-HE STA, and the third field indicates that the non-HE PPDU is present on the primary 160 MHz channel; where a channel for transmission of the non-HE PPDU by the non-HE STA is a primary 80 MHz channel within the primary 160 MHz channel, and is indicated by the first field and the second field. The TB A-PPDU may consist of the non-HE PPDU in the primary channel and one or more PPDUs in the secondary channel(s). In an example, B54=0 and UL BW=2 indicates the non-HE PPDU in P80; B54=0, UL BW=3, UL BW Extension=1 indicates the non-HE PPDU in P160. Similar to the above case when HE PPDU is indicated to be present in P160, the indication of non-HE PPDU in P160 can be achieved by the third field per se, but the indication of non-HE PPDU in P80 would be achieved based on the first field and the second field when the third field indicates that the non-HE PPDU is present on the primary 160 MHz channel. Besides, as shown in the example in FIG. 5, the non-HE PPDU in P80 may be an EHT PPDU or a UHR PPDU, so when different types of PPDU appear in P80 of P160, PHY version Identifier can be used to further distinguish their types, which would be described later with specific examples.

As described above, the at least one of the plural PPDUs is PPDU(s) requested to be transmitted on a secondary channel. In a possible implementation, the at least one of the plural PPDUs includes one or more of: a HE PPDU requested to be transmitted on a secondary 80 MHz channel by a non-AP ultra-high reliability (UHR) station (STA) in response to reception of the frame; an EHT PPDU requested to be transmitted on a secondary 80 MHz channel or a secondary 160 MHz channel by a non-AP UHR STA in response to reception of the frame; a UHR PPDU requested to be transmitted on a secondary 80 MHz channel or a secondary 160 MHz channel by a non-AP UHR STA in response to reception of the frame. One of the constituent PPDUs of the TB A-PPDU may be a HE PPDU from UHR STA/an EHT PPDU from UHR STA/a UHR PPDU. According to the aforementioned possible TB A-PPDU UHR combinations, to be more specific, the PPDU(s) transmitted by UHR STA may be a HE PPDU by UHR STA in S80, an EHT PPDU by UHR STA in S80 or S160, or a UHR PPDU in S80 or S160.

Regarding the PPDU type indication for the TB A-PPDU UHR combinations in other cases, in a possible implementation, the frame further includes a physical layer (PHY) Version Identifier subfield corresponding to each of the at least one of the plural PPDUs for indicating a type of each of the at least one of the plural PPDUs. The PHY Version Identifier subfield may be set to values 0-7. As shown in FIG. 6, value 0 is assigned to indicate the EHT PPDU type. The reserved values 1-7 can be assigned to indicate other types of PPDU(s), e.g., value 1 may be assigned to indicate the UHR PPDU type, value 7 may be assigned to indicate the HE PPDU by UHR STA type, which will be further described later. For example, when a non-HE PPDU is present, a Special User Info field could be present to indicate extra control information for the corresponding non-HE PPDU, and the PHY Version Identifier subfield could belong to the Special User Info field for the corresponding non-HE PPDU.

In a possible implementation, the at least one of the plural PPDUs which is requested to be transmitted on a secondary channel includes one PPDU, and a type of the one PPDU is indicated by a reserved value for the PHY Version Identifier subfield corresponding to the one PPDU. In some cases, the TB A-PPDU may consist of two PPDUs, one is on the primary channel, while another is on the secondary channel. As mentioned before, the type of the PPDU on the primary channel can be indicated by a corresponding bit in the Common Info field. Based on the example shown in FIG. 5, the type of the PPDU on the secondary channel may be a PPDU by UHR STA (to be transmitted from a UHR STA), e.g., a HE PPDU from UHR STA/an EHT PPDU from UHR STA/a UHR PPDU. In this case, the PPDU type can be indicated by a reserved value for the PHY Version Identifier subfield of this PPDU. Specific examples will be given later, e.g., the PPDU type indication for the HE PPDU by UHR STA in S80 in the aforementioned mode (1) of the TB A-PPDU UHR combinations, the UHR PPDU in S80 in the aforementioned mode (2), or the UHR PPDU in S160 in the aforementioned mode (a), the EHT PPDU by UHR STA in S160 in the aforementioned mode (c), etc.

In a possible implementation, the at least one of the plural PPDUs includes more than one PPDU, and types of different PPDUs among the more than one PPDU are indicated by different values carried in PHY Version Identifier subfields corresponding to the more than one PPDU respectively. In the case that there are more than one PPDU to be transmitted on a secondary channel and of which the transmission channels being indicated through corresponding reserved combinations of the UL BW field and the UL BW Extension subfield, the frame may further indicate a presence of Special User Info fields including the PHY Version Identifier subfields respectively. In some cases, the TB A-PPDU may consist of two PPDUs, and the PPDU type is indicated by the value carried in PHY Version Identifier subfield of the Special User Info field corresponding to each of the PPDUs. In some cases, the TB A-PPDU may consist of more than two PPDUs, one is on the primary channel, while others are on the secondary channels. The type of the PPDU on the primary channel can be indicated by a corresponding bit (e.g., B54) in the Common Info field. The types of the PPDUs on the secondary channels may be a PPDU by UHR STA, e.g., a HE PPDU from UHR STA/an EHT PPDU from UHR STA/a UHR PPDU, and can be indicated by different values carried in PHY Version Identifier subfields. Specific examples will be given later, e.g., the PPDU type indication for the EHT PPDU in P160+UHR PPDU in S160 in the aforementioned mode (b), HE PPDU by UHR STA in S80+UHR PPDU in S160 in the aforementioned mode (d), EHT PPDU by UHR STA in S80+UHR PPDU in S160 in the aforementioned mode (e), HE PPDU by UHR STA in S80+EHT PPDU by UHR STA in S160 in the aforementioned mode (f).

As mentioned before, the reserved values of the PHY Version Identifier subfield can be utilized to define x-variant PPDU, and the reserved values of the UL Bandwidth Extension subfield can be utilized to support TB A-PPDUs with different UL bandwidths. In a possible implementation, the PHY Version Identifier subfield is assigned with a value of 1 for indicating a type of a requested PPDU being a UHR PPDU or a HE PPDU from a non-AP UHR STA, e.g., the UHR PPDU in mode (2) and the HE PPDU by UHR STA in mode (1) can be indicated by UL BW=2, UL BW Extension=1 and UL BW=2, UL BW Extension=3 together with a value of 1 in the PHY Version Identifier subfield respectively. In a possible implementation, the PHY Version Identifier subfield is assigned with a value of 7 for indicating a type of a requested PPDU being a HE PPDU from a non-AP UHR STA. Specific examples will be given later with reference to the signaling solution for TB A-PPDU UHR combinations.

As described above, the at least one PPDU may be requested to be transmitted on a secondary channel which is indicated through the reserved combination of the first field and the second field, in a possible implementation, this secondary channel indicated through the reserved combination of the first field and the second field is a secondary 80 MHz channel or a secondary 160 MHz channel. In a possible implementation, in the reserved combination of the first field and the second field for indicating the secondary 80 MHz channel, the first field is assigned with a value of 2 and the second field is assigned with a value of 1 or 3. In a possible implementation, in the reserved combination of the first field and the second field for indicating the secondary 160 MHz channel, the first field is assigned with a value of 2 and the second field is assigned with a value of 2. In a possible implementation, in the reserved combination of the first field and the second field for indicating the secondary 160 MHz channel, the first field is assigned with a value of 3 and the second field is assigned with a value of 0. Specific examples will be given later with reference to the signaling solution for TB A-PPDU UHR combinations.

In a possible implementation, when the at least one PPDU includes a UHR PPDU and an EHT PPDU, the frame further includes a fifth field between a UHR User Info field carrying user information of the UHR PPDU and a Special User Info field corresponding to the EHT PPDU; where the fifth field carries a frame check sequence (FCS) for the UHR PPDU. The frame format may be as shown in FIG. 8B. As shown in FIG. 8B, 32 bits Intermediate FCS1 User Info field and 32 bits Intermediate FCS2 User Info field (specific examples of the fifth field) are inserted between the UHR and EHT variants. In a possible implementation, the frame further indicates that the at least one PPDU includes the UHR PPDU and the EHT PPDU. In a possible implementation, the indication of the at least one PPDU including the UHR PPDU and the EHT PPDU is carried in a Common Info field of the frame. In this case, UHR STA will decode only its UHR Special User Info field, its UHR User Info field, and the Intermediate FCS user Info field(s), thereby reducing the amount of data to be processed, and improving the decoding efficiency. One of the reserved bits within the Common field may be utilized to indicate the TB A-PPDU with EHT PPDU+UHR PPDU. One of the reserved bits within the Common field may be utilized to indicate the presence of more than one Special User Info fields within the User Info List when the value of B55 is set to 0. B12 and B39 in the User Info field can be re-purposed for defining other UHR information.

The above describes the solution from the perspective of the AP, and next the solution will be described from the perspective of the STA.

A STA receives the frame transmitted by the AP, where the frame is used for requesting transmission of plural PPDU, and the frame includes a first field indicating bandwidth information for the transmission of the plural PPDUs and a second field indicating bandwidth extended information for transmission of at least one of the plural PPDUs; where a channel for the transmission of the at least one of the plural PPDUs is indicated through a reserved combination of the first field and the second field. The STA may transmit a PPDU among the plural PPDUs based on the received frame.

As mentioned before, the STA may be a HE STA, an EHT STA, or a UHR STA, or any next-generation STA. An STA may read corresponding fields of the received frame to obtain the indication information associated with a PPDU to be transmitted by itself, and transmit a PPDU according to the indication information (e.g., the PPDU type and the channel for transmission of the PPDU). One or more STAs will respond to the frame transmitted by the AP, and send PPDUs to the AP. Then at the AP side, AP receives all the PPDUs. Regarding the details about the frame, reference may be made to the foregoing description at the AP side, which will not be repeated for brevity.

Next, specific implementations about the generalized signaling for the aforementioned possible TB A-PPDU UHR combinations will be elaborated in the following.

### Mode (1) Option 1

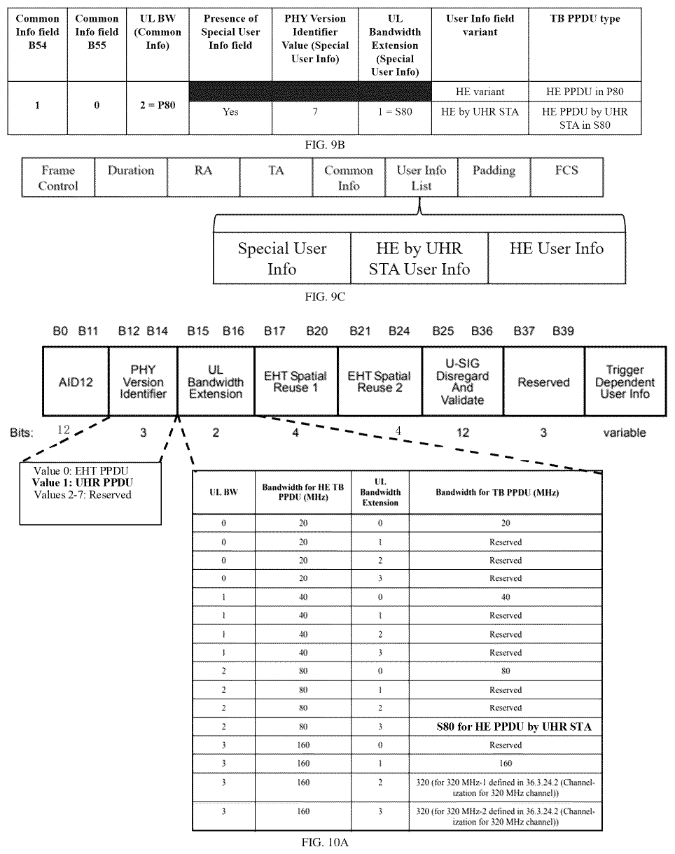

As mentioned before, mode (1) refers to the TB A-PPDU signaling for a combination of 80 MHz HE PPDU+80 MHz HE PPDU (by UHR STA). As shown in FIG. 9A, the parameters of the HE PPDU in primary 80 MHz channel (P80) can be indicated easily in the Common Info field by setting B54=1 and UL BW=2 to indicate that the HE PPDU will be in the P80.

For the HE PPDU (by UHR STA) in secondary 80 MHz channel (S80), a Special User Info field should precede the HE by UHR STA User Info field (the UHR variant Special User Info field, which may use the same format of the aforementioned EHT variant Special User Info field) to specify its parameters, such as the PPDU type and bandwidth location. It is proposed to use the same format of the Special User Info Field supported by EHT variant by repurposing the reserved value of 7 in the PHY Version Identifier subfield to indicate HE PPDU (by UHR STA) and the reserved value of 1 in the UL bandwidth extension subfield with UL BW=2 to indicate S80.

As a result, the values of B54, B55, and UL BW subfield in the Common Info field, as well as the values of the PHY Version Identifier and UL Bandwidth Extension subfields in the Special User Info field, will be as shown in FIG. 9B. The format of the TB A-PPDU will be as shown in FIG. 9C. It should be noted that, the Special User Info field should precede the UHR (variant) User Info field (the HE by UHR STA User Info field in FIG. 9C), and the order of the HE User Info field can be changed. That is, the HE User Info field being after the HE by UHR STA User Info field as shown in FIG. 9C is illustrative, the HE User Info field can also be located before the Special User Info field, which is not limited in the embodiments of the present disclosure.

### Mode (1) Option 2

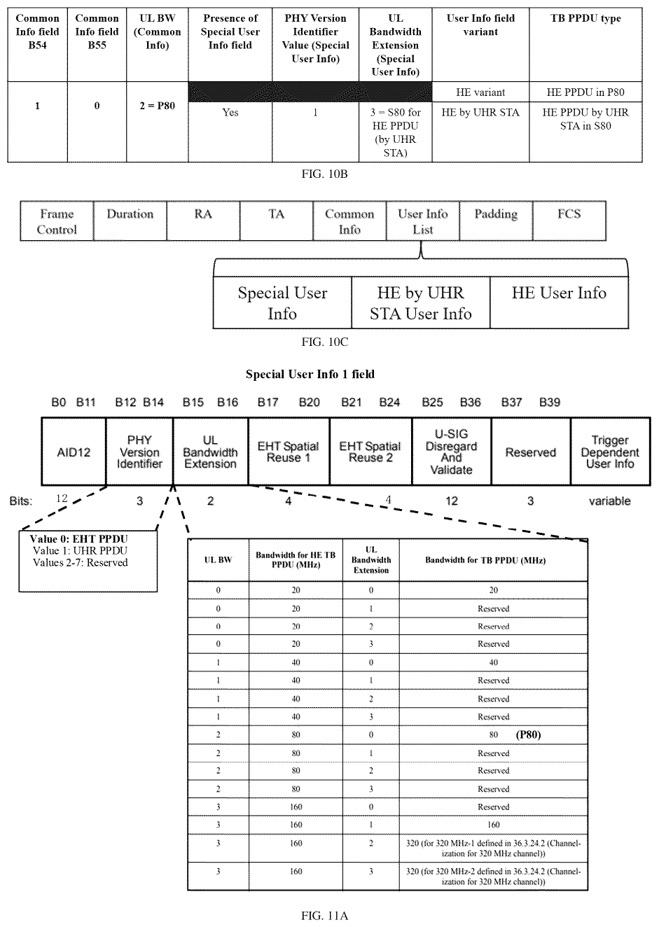

The above describes a possible implementation for mode (1), and there may be another option for its implementation. As shown in FIG. 10A, the parameters of the HE PPDU in P80 can be indicated easily in the Common Info field by setting B54=1 and UL BW=2 to indicate that the HE PPDU will be in the P80.

For the HE PPDU (by UHR STA) in S80, a Special User Info field should precede the HE by UHR STA User Info field to specify its parameters, such as the PPDU type and bandwidth location. It is proposed to use the same format of the Special User Info Field supported by EHT variant by repurposing the reserved value of 1 in the PHY Version Identifier subfield to indicate UHR PPDU and the reserved value of 3 in the UL bandwidth extension subfield with UL BW=2 to indicate S80 for HE PPDU (by UHR STA). Following this, the reserved values (2-7) in the PHY Version Identifier subfield are saved as much as possible to keep enough space for future generations.

As a result, the values of B54, B55, and UL BW subfield in the Common Info field, as well as the values of the PHY Version Identifier and UL Bandwidth Extension subfields in the Special User Info field, will be as shown in FIG. 10B. The format of the TB A-PPDU will be as shown in FIG. 10C. It should be noted that, the Special User Info field should precede the HE by UHR STA User Info field, and the order of the HE User Info field can be changed. That is, the HE User Info field being after the HE by UHR STA User Info field as shown in FIG. 10C is illustrative, the HE User Info field can also be located before the Special User Info field, which is not limited in the embodiments of the present disclosure. Besides, it should be noted that in this case, the reserved value of 1 in the PHY Version Identifier subfield still indicates a HE PPDU instead of a UHR PPDU, but this HE PPDU is to be transmitted from a UHR STA. When a UHR STA receives the frame, it can tell from B54 that there is HE PPDU in P160, and then based on value 1 of the PHY Version Identifier subfield, it can tell that a HE PPDU is requested to be transmitted from its side. For STAs other than UHR STA, e.g., an EHT STA, it will not transmit the HE PPDU since the value of the PHY Version Identifier subfield prohibits such behavior. In option 2, the PHY Version Identifier is set to 1 to indicate a UHR type. However, since the UL BW Extension value is set to 3, indicating S80 for an HE PPDU by a UHR STA, the UHR STA will interpret the solicited PPDU as an HE PPDU, not a UHR PPDU.

### Mode (2)

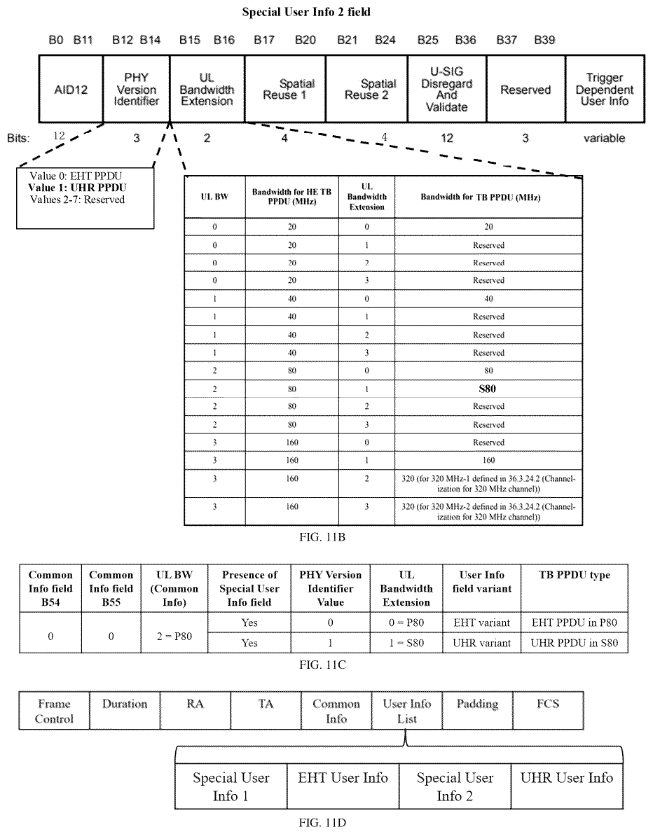

As mentioned before, mode (2) refers to the TB A-PPDU signaling for a combination of 80 MHz EHT PPDU+80 MHz UHR PPDU. As shown in FIG. 11A, for the EHT PPDU in P80, a Special User Info 1 field should precede the EHT (variant) User Info field to specify its parameters, such as the PPDU type and bandwidth location. It is proposed to use the reserved value of 0 in the PHY Version Identifier subfield to indicate EHT PPDU and UL BW=2 to indicate P80 for EHT PPDU.

As shown in FIG. 11B, for the UHR PPDU in S80, a Special User Info field 2 should precede the UHR (variant) User Info field to specify its parameters, such as the PPDU type and bandwidth location. It is proposed to use the reserved value of 1 in the PHY Version Identifier subfield to indicate UHR PPDU and the reserved value of 1 in the UL bandwidth extension subfield with UL BW=2 to indicate S80 for UHR PPDU.

As a result, the values of B54, B55, and UL BW subfield in the Common Info field, as well as the values of the PHY Version Identifier and UL Bandwidth Extension subfields in the Special User Info field, will be as shown in FIG. 11C. The format of the TB A-PPDU will be as shown in FIG. 11D. It should be noted that, the order of the Special User Info 1 field+the EHT User Info field and the Special User Info 2 field+the UHR User Info field can be changed. That is, the Special User Info 1 field+the EHT User Info field can be located before or after the Special User Info 2 field+the UHR User Info field, which is not limited in the embodiments of the present disclosure.

### Mode (a)

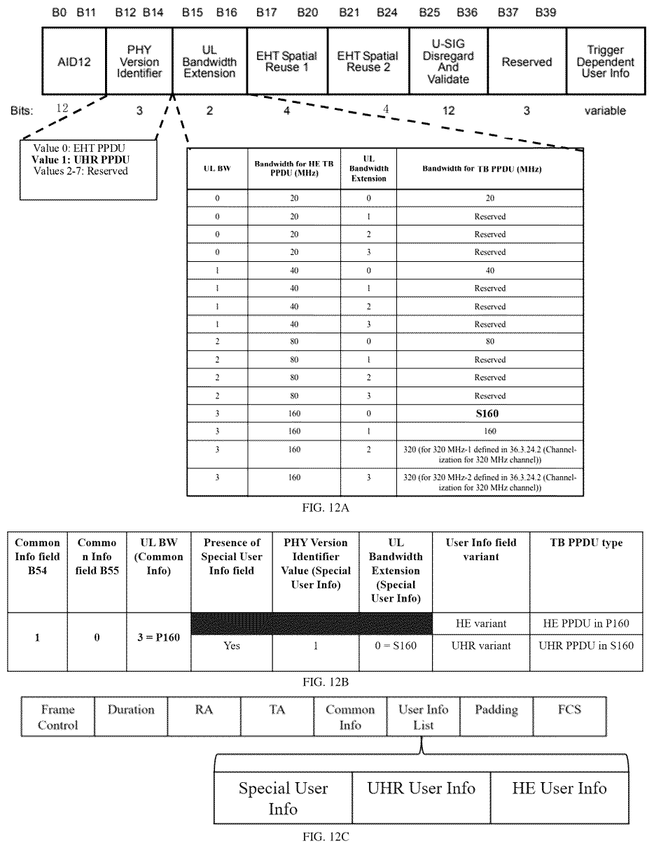

As mentioned before, mode (a) refers to the TB A-PPDU signaling for a combination of 160 MHz HE PPDU+160 MHz UHR PPDU. As shown in FIG. 12A, the parameters of the HE PPDU in P160 can be indicated easily in the Common Info field by setting B54=1 and UL BW=3 to indicate that the HE PPDU will be in the P160.

For the UHR PPDU in S160, a Special User Info field should precede the UHR User Info field to specify its parameters, such as the PPDU type and bandwidth location. It is proposed to use the same format of the Special User Info Field supported by EHT variant by repurposing the reserved value of 1 in the PHY Version Identifier subfield to indicate UHR PPDU and the reserved value of 0 in the UL bandwidth extension subfield with UL BW=3 to indicate S160 for UHR PPDU. Following this, the reserved values (2-7) in the PHY Version Identifier subfield are saved as much as possible to keep enough space for future generations.

As a result, the values of B54, B55, and UL BW subfield in the Common Info field, as well as the values of the PHY Version Identifier and UL Bandwidth Extension subfields in the Special User Info field, will be as shown in FIG. 12B. The format of the TB A-PPDU will be as shown in FIG. 12C. It should be noted that, the Special User Info field should precede the HE by UHR STA User Info field, and the order of the HE User Info field can be changed. That is, the HE User Info field being after the UHR User Info field as shown in FIG. 12C is illustrative, the HE User Info field can also be located before the Special User Info field, which is not limited in the embodiments of the present disclosure.

### Mode (b)

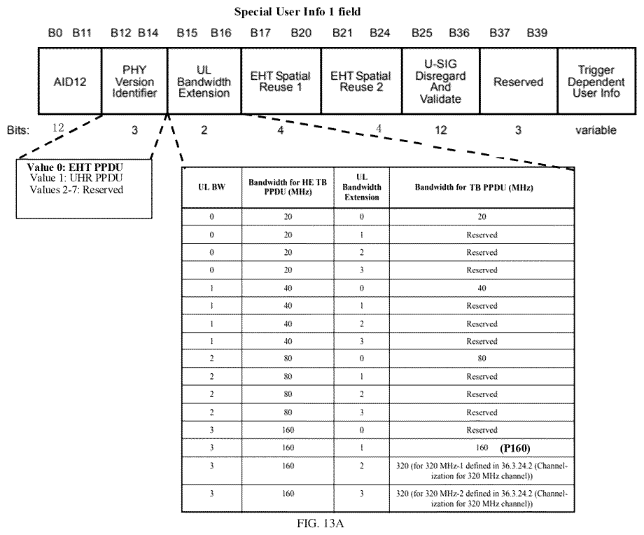

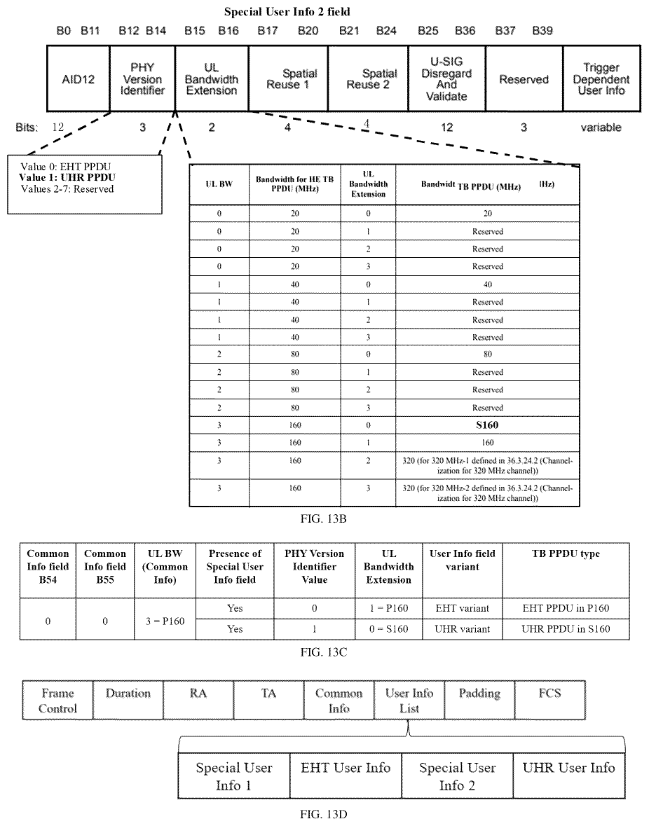

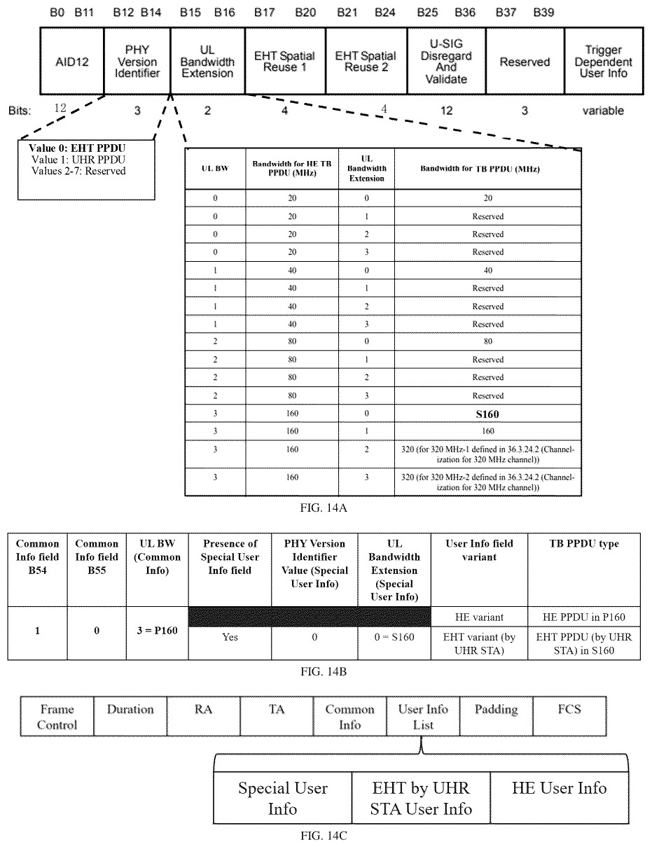

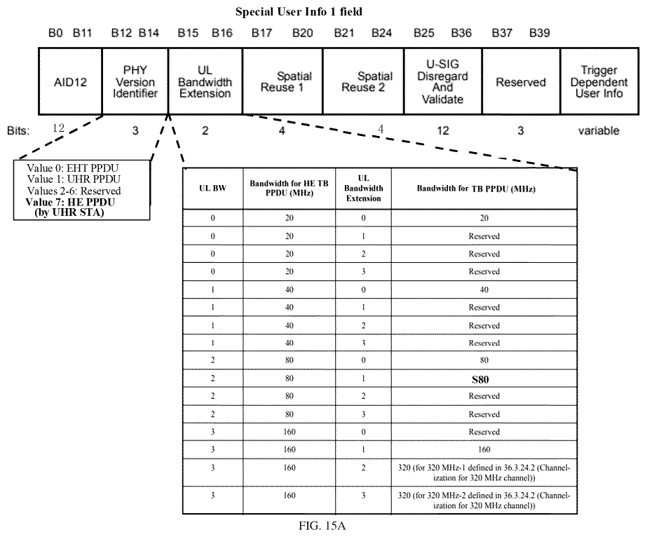

As mentioned before, mode (b) refers to the TB A-PPDU signaling for a combination of 160 MHz EHT PPDU+160 MHz UHR PPDU. As shown in FIG. 13A, for the EHT PPDU in P160, a Special User Info 1 field should precede the EHT (variant) User Info field to specify its parameters, such as the PPDU type and bandwidth location. It is proposed to use the reserved value of 0 in the PHY Version Identifier subfield to indicate EHT PPDU and UL BW=3 to indicate P160 for EHT PPDU.

As shown in FIG. 13B, for the UHR PPDU in S160, a Special User Info field 2 should precede the UHR (variant) User Info field to specify its parameters, such as the PPDU type and bandwidth location. It is proposed to use the reserved value of 1 in the PHY Version Identifier subfield to indicate UHR PPDU and the reserved value of 0 in the UL bandwidth extension subfield with UL BW=3 to indicate S160 for UHR PPDU. Following this, the reserved values (2-7) in the PHY Version Identifier subfield are saved as much as possible to keep enough space for future generations.

As a result, the values of B54, B55, and UL BW subfield in the Common Info field, as well as the values of the PHY Version Identifier and UL Bandwidth Extension subfields in the Special User Info field, will be as shown in FIG. 13C. The format of the TB A-PPDU will be as shown in FIG. 13D. It should be noted that, the order of the Special User Info 1 field+the EHT User Info field and the Special User Info 2 field+the UHR User Info field can be changed. That is, the Special User Info 1 field+the EHT User Info field can be located before or after the Special User Info 2 field+the UHR User Info field, which is not limited in the embodiments of the present disclosure.

### Mode (c)

As mentioned before, mode (c) refers to the TB A-PPDU signaling for a combination of 160 MHz HE PPDU+160 MHz EHT PPDU (by UHR STA). As shown in FIG. 14A, the parameters of the HE PPDU in P160 can be indicated easily in the Common Info field by setting B54=1 and UL BW=3 to indicate that the HE PPDU will be in the P160.

For the EHT PPDU (by UHR STA) in S160, a Special User Info field should precede the EHT by UHR STA User Info field to specify its parameters, such as the PPDU type and bandwidth location. It is proposed to use the same format of the Special User Info Field supported by EHT variant by repurposing the reserved value of 0 in the PHY Version Identifier subfield to indicate EHT PPDU and the reserved value of 0 in the UL bandwidth extension subfield with UL BW=3 to indicate S160 for EHT PPDU (by UHR STA). Following this, the reserved values (2-7) in the PHY Version Identifier subfield are saved as much as possible to keep enough space for future generations.

As a result, the values of B54, B55, and UL BW subfield in the Common Info field, as well as the values of the PHY Version Identifier and UL Bandwidth Extension subfields in the Special User Info field, will be as shown in FIG. 14B. The format of the TB A-PPDU will be as shown in FIG. 14C. It should be noted that, the Special User Info field should precede the EHT by UHR STA User Info field, and the order of the HE User Info field can be changed. That is, the HE User Info field being after the EHT by UHR STA User Info field as shown in FIG. 14C is illustrative, the HE User Info field can also be located before the Special User Info field, which is not limited in the embodiments of the present disclosure.

### Mode (d) Option 1

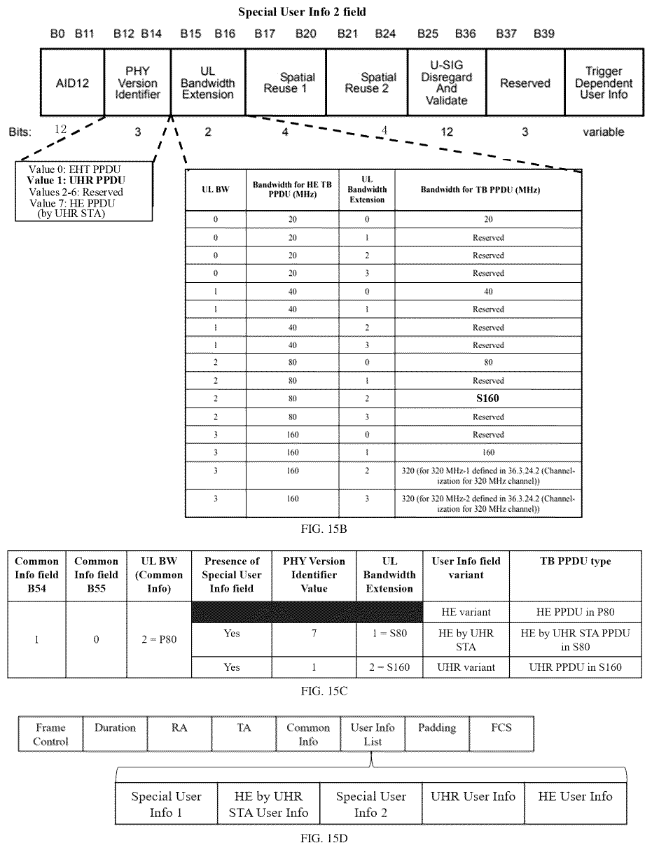

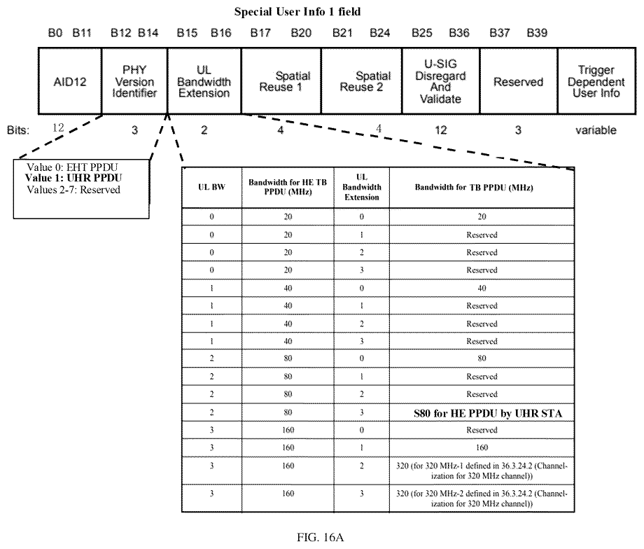

As mentioned before, mode (d) refers to the TB A-PPDU signaling for a combination of 80 MHz HE PPDU+80 MHz HE PPDU (by UHR STA)+160 MHz UHR PPDU. As shown in FIG. 15A, the parameters of the HE PPDU in P80 can be indicated easily in the Common Info field by setting B54=1 and UL BW=2 to indicate that the HE PPDU will be in the P80.

As shown in FIG. 15A, for the HE PPDU (by UHR STA) in S80, a Special User Info 1 field should precede the HE by UHR STA User Info field to specify its parameters, such as the PPDU type and bandwidth location. It is proposed to use the same format of the Special User Info Field supported by EHT variant by repurposing the reserved value of 7 in the PHY Version Identifier to indicate HE PPDU (by UHR STA) and the reserved value of 1 in the UL bandwidth extension with UL BW=2 to indicate S80.

As shown in FIG. 15B, for the UHR PPDU in S160, a Special User Info 2 field should precede the UHR User Info field to specify its parameters, such as the PPDU type and bandwidth location. It is proposed to use the same format of the Special User Info Field supported by EHT variant by repurposing the reserved value of 1 in the PHY Version Identifier to indicate UHR PPDU and the reserved value of 2 in the UL bandwidth extension with UL BW=2 to indicate S160.

As a result, the values of B54, B55, and UL BW subfield in the Common Info field, as well as the values of the PHY Version Identifier and UL Bandwidth Extension subfields in the Special User Info field, will be as shown in FIG. 15C. The format of the TB A-PPDU will be as shown in FIG. 15D. It should be noted that, the order of the Special User Info 1 field+the HE by UHR STA User Info field, the Special User Info 2 field+the UHR User Info field, and the HE User Info field can be changed. That is, the Special User Info 1 field+the HE by UHR STA User Info field can be located before or after the Special User Info 2 field+the UHR User Info field, the HE User Info field can also be located before or after the Special User Info 1 field+the HE by UHR STA User Info field (or the Special User Info 2 field+the UHR User Info field), which is not limited in the embodiments of the present disclosure.

### Mode (d) Option 2

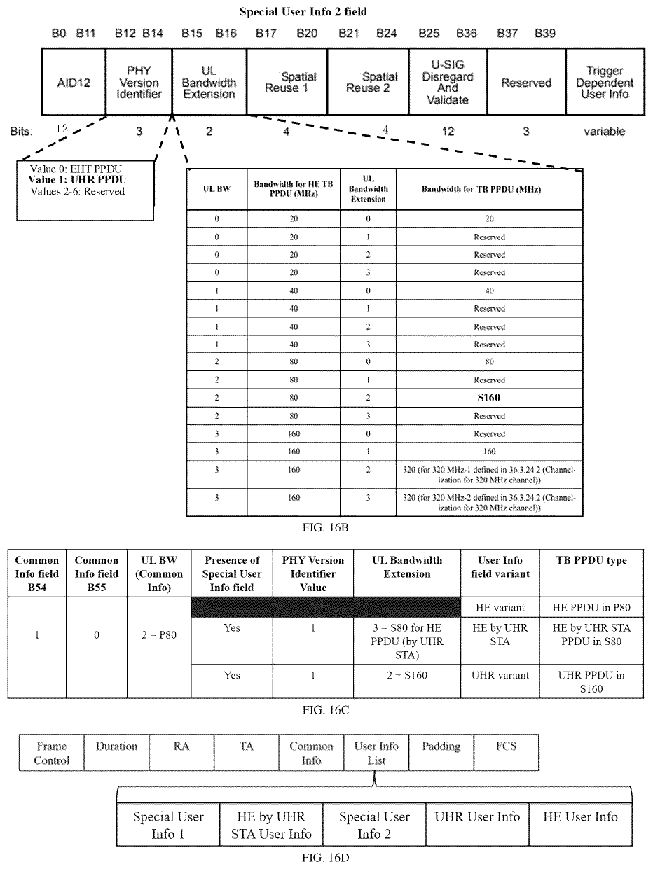

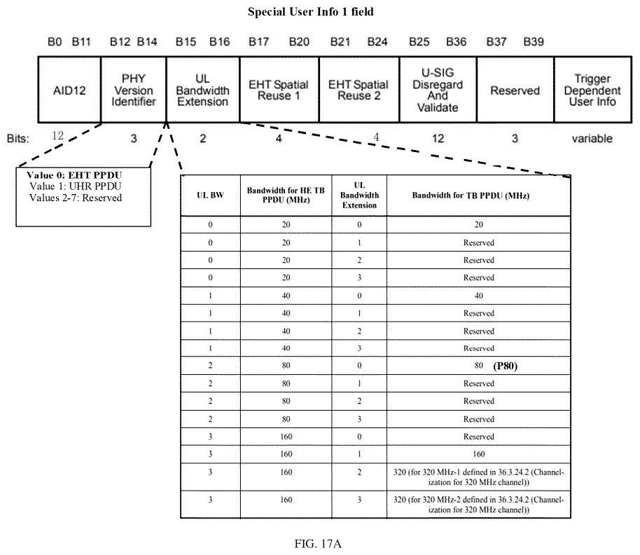

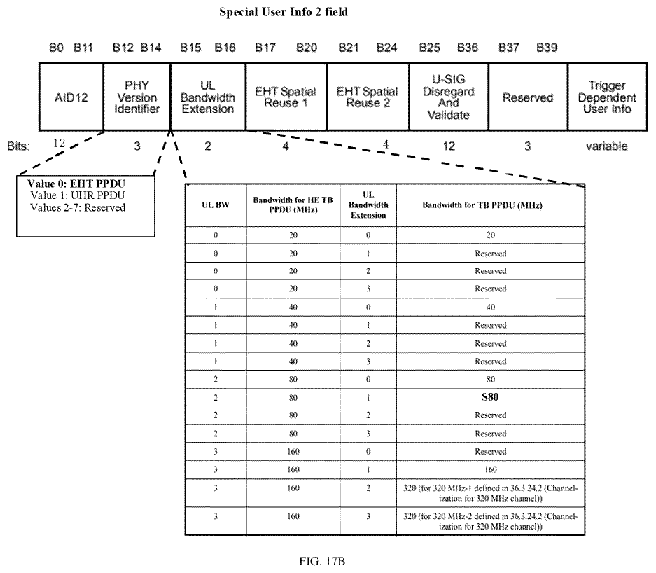

The above describes a possible implementation for mode (d), and there may be another option for its implementation. As shown in FIG. 16A, the parameters of the HE PPDU in P80 can be indicated easily in the Common Info field by setting B54=1 and UL BW=2 to indicate that the HE PPDU will be in the P80.

As shown in FIG. 16A, for the HE PPDU (by UHR STA) in S80, a Special User Info 1 field should precede the HE by UHR STA User Info field to specify its parameters, such as the PPDU type and bandwidth location. It is proposed to use the same format of the Special User Info Field supported by EHT variant by repurposing the reserved value of 1 in the PHY Version Identifier to indicate UHR PPDU and the reserved value of 3 in the UL bandwidth extension with UL BW=2 to indicate S80 for HE PPDU (by UHR STA).

As shown in FIG. 16B, for the UHR PPDU in S160, a Special User Info 2 field should precede the UHR User Info field to specify its parameters, such as the PPDU type and bandwidth location. It is proposed to use the same format of the Special User Info Field supported by EHT variant by repurposing the reserved value of 1 in the PHY Version Identifier to indicate UHR PPDU and the reserved value of 2 in the UL bandwidth extension with UL BW=2 to indicate S160.

As a result, the values of B54, B55, and UL BW subfield in the Common Info field, as well as the values of the PHY Version Identifier and UL Bandwidth Extension in the Special User Info field, will be shown in FIG. 16C. The format of the TB A-PPDU will be as shown in FIG. 15D. It should be noted that, the order of the Special User Info 1 field+the HE by UHR STA User Info field, the Special User Info 2 field+the UHR User Info field, and the HE User Info field can be changed. That is, the Special User Info 1 field+the HE by UHR STA User Info field can be located before or after the Special User Info 2 field+the UHR User Info field, the HE User Info field can also be located before or after the Special User Info 1 field+the HE by UHR STA User Info field (or the Special User Info 2 field+the UHR User Info field), which is not limited in the embodiments of the present disclosure.

### Mode (e)

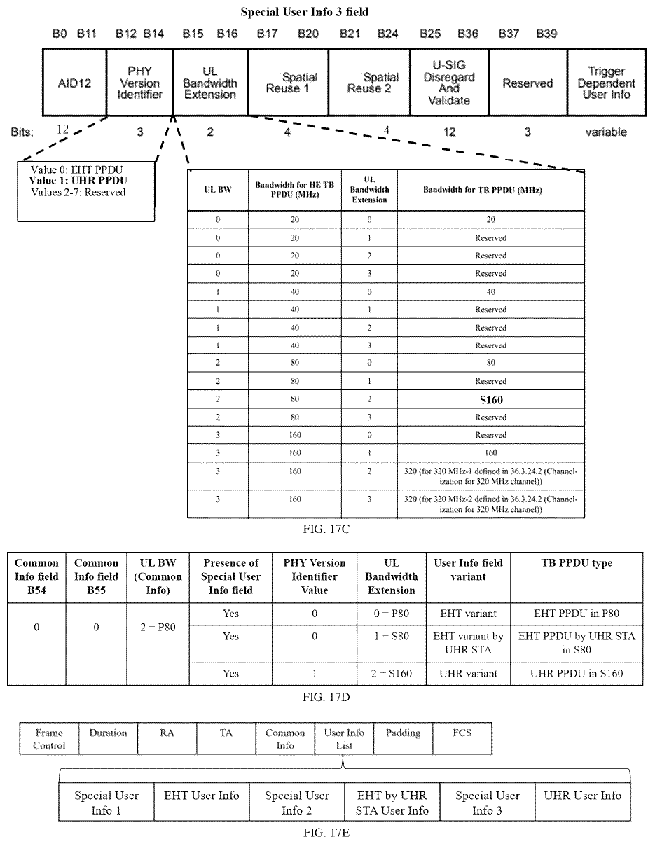

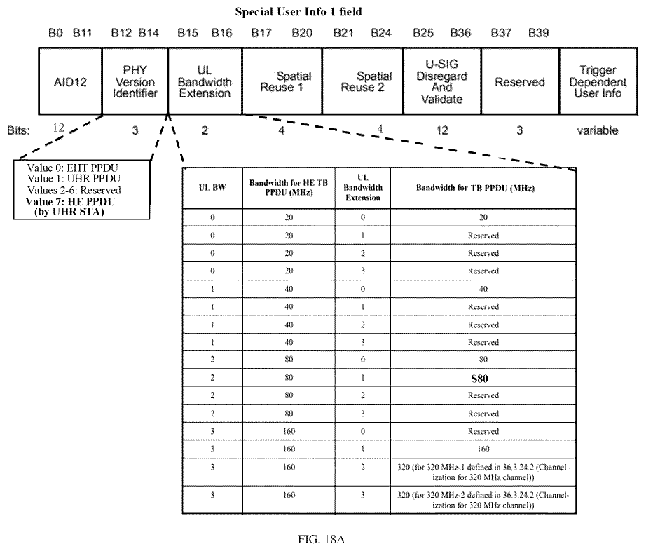

As mentioned before, mode (e) refers to the TB A-PPDU signaling for a combination of 80 MHz EHT PPDU+80 MHz EHT PPDU (by UHR STA)+160 MHz UHR PPDU. As shown in FIG. 17A, for the EHT PPDU in P80, a Special User Info 1 field should precede the EHT (variant) User Info field to specify its parameters, such as the PPDU type and bandwidth location. It is proposed to use the reserved value of 0 in the PHY Version Identifier subfield to indicate EHT PPDU and UL BW=2 to indicate P80 for EHT PPDU.

As shown in FIG. 17B, for the EHT PPDU (by UHR STA) in S80, a Special User Info field 2 should precede the EHT by UHR STA User Info field to specify its parameters, such as the PPDU type and bandwidth location. It is proposed to use the reserved value of 0 in the PHY Version Identifier subfield to indicate EHT PPDU and the reserved value of 1 in the UL bandwidth extension subfield with UL BW=2 to indicate S80 for UHR PPDU.

As shown in FIG. 17C, for the UHR PPDU in S160, a Special User Info field 3 should precede the UHR User Info field to specify its parameters, such as the PPDU type and bandwidth location. It is proposed to use the reserved value of 1 in the PHY Version Identifier subfield to indicate UHR PPDU and the reserved value of 2 in the UL bandwidth extension subfield with UL BW=2 to indicate S160 for UHR PPDU.

As a result, the values of B54, B55, and UL BW subfield in the Common Info field, as well as the values of the PHY Version Identifier and UL Bandwidth Extension subfields in the Special User Info field, will be as shown in FIG. 17D. The format of the TB A-PPDU will be as shown in FIG. 17E. It should be noted that, the order of the Special User Info 1 field+the EHT User Info field, the Special User Info 2 field+the EHT by UHR STA User Info field, and the Special User Info 3 field+the UHR User Info field can be changed. That is, the Special User Info 1 field+the EHT User Info field can be located before or after the Special User Info 2 field+the EHT by UHR STA User Info field (or the Special User Info 3 field+the UHR User Info field), the Special User Info 3 field+the UHR User Info field can also be located before or after the Special User Info 1 field+the EHT User Info field (or the Special User Info 2 field+the EHT by UHR STA User Info field), which is not limited in the embodiments of the present disclosure.

### Mode (f) Option 1

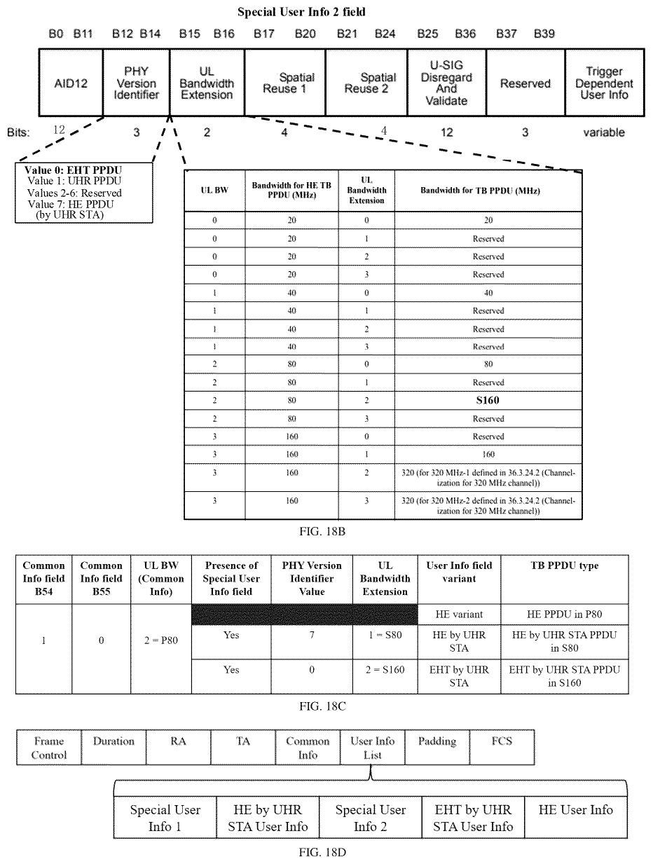

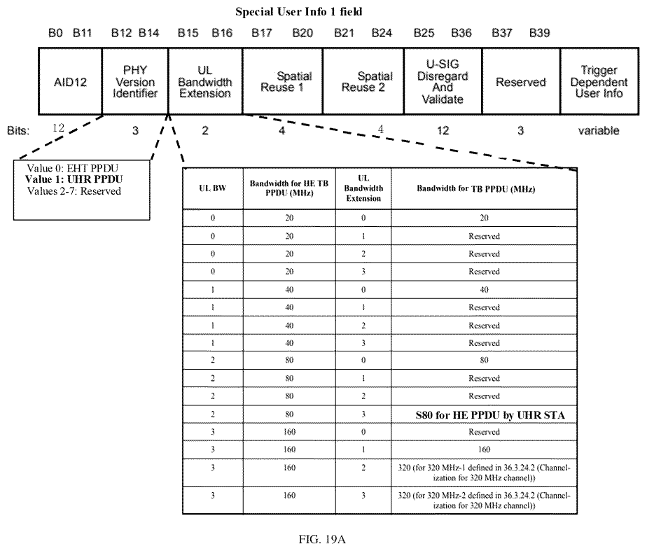

As mentioned before, mode (f) refers to the TB A-PPDU signaling for a combination of 80 MHz HE PPDU+80 MHz HE PPDU (by UHR STA)+160 MHz EHT PPDU (by UHR STA). As shown in FIG. 18A, the parameters of the HE PPDU in P80 can be indicated easily in the Common Info field by setting B54=1 and UL BW=2 to indicate that the HE PPDU will be in the P80.

As shown in FIG. 18A, for the HE PPDU (by UHR STA) in S80, a Special User Info 1 field should precede the HE by UHR STA User Info field to specify its parameters, such as the PPDU type and bandwidth location. It is proposed to use the same format of the Special User Info Field supported by EHT variant by repurposing the reserved value of 7 in the PHY Version Identifier to indicate HE PPDU (by UHR STA) and the reserved value of 1 in the UL bandwidth extension with UL BW=2 to indicate S80.

As shown in FIG. 18B, for the EHT PPDU (by UHR STA) in S160, a Special User Info 2 field should precede the EHT by UHR STA User Info field to specify its parameters, such as the PPDU type and bandwidth location. It is proposed to use the same format of the Special User Info Field supported by EHT variant by repurposing the reserved value of 0 in the PHY Version Identifier to indicate EHT PPDU and the reserved value of 2 in the UL bandwidth extension with UL BW=2 to indicate S160.

As a result, the values of B54, B55, and UL BW subfield in the Common Info field, as well as the values of the PHY Version Identifier and UL Bandwidth Extension subfields in the Special User Info field, will be as shown in FIG. 18C. The format of the TB A-PPDU will be as shown in FIG. 18D. It should be noted that, the order of the Special User Info 1 field+the HE by UHR STA User Info field, the Special User Info 2 field+the EHT by UHR STA User Info field, and the HE User Info field can be changed. That is, the Special User Info 1 field+the HE by UHR STA User Info field can be located before or after the Special User Info 2 field+the EHT by UHR STA User Info field (or the HE User Info field), the HE User Info field can also be located before or after the Special User Info 1 field+the HE by UHR STA User Info field (the Special User Info 2 field+the EHT by UHR STA User Info field), which is not limited in the embodiments of the present disclosure.

### Mode (f) Option 2

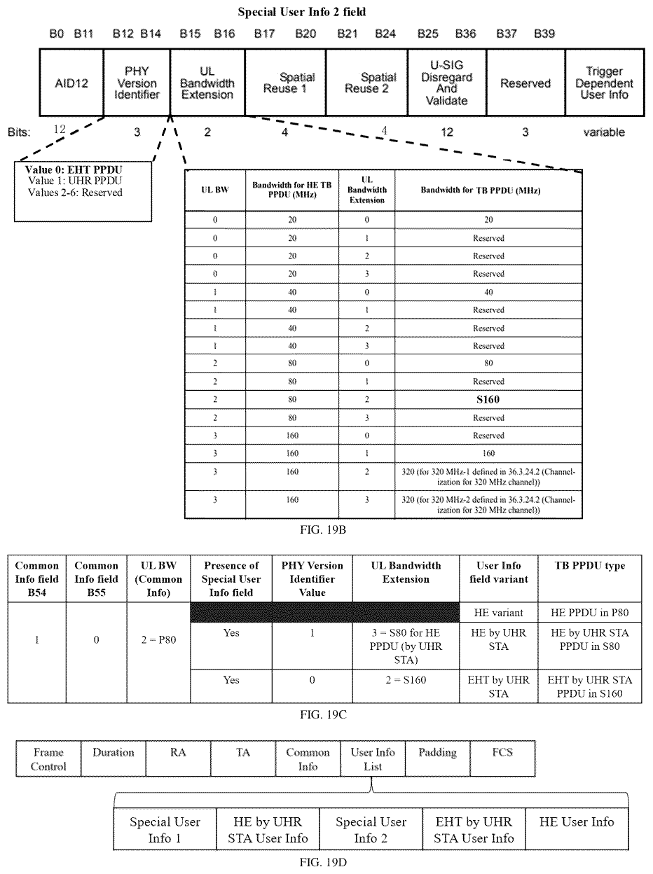

The above describes a possible implementation for mode (e), and there may be another option for its implementation. As shown in FIG. 19A, the parameters of the HE PPDU in P80 can be indicated easily in the Common Info field by setting B54=1 and UL BW=2 to indicate that the HE PPDU will be in the P80.

As shown in FIG. 19A, for the HE PPDU (by UHR STA) in S80, a Special User Info 1 field should precede the HE by UHR STA User Info field to specify its parameters, such as the PPDU type and bandwidth location. It is proposed to use the same format of the Special User Info Field supported by EHT variant by repurposing the reserved value of 1 in the PHY Version Identifier to indicate UHR PPDU and the reserved value of 3 in the UL bandwidth extension with UL BW=2 to indicate S80 for HE PPDU (by UHR STA).

As shown in FIG. 19B, for the EHT PPDU (by UHR STA) in S160, a Special User Info 2 field should precede the EHT by UHR STA User Info field to specify its parameters, such as the PPDU type and bandwidth location. It is proposed to use the same format of the Special User Info Field supported by EHT variant by repurposing the reserved value of 0 in the PHY Version Identifier to indicate EHT PPDU and the reserved value of 2 in the UL bandwidth extension with UL BW=2 to indicate S160.

As a result, the values of B54, B55, and UL BW subfield in the Common Info field, as well as the values of the PHY Version Identifier and UL Bandwidth Extension in the Special User Info field, will be shown in FIG. 19C. The format of the TB A-PPDU will be as shown in FIG. 19D. It should be noted that, the order of the Special User Info 1 field+the HE by UHR STA User Info field, the Special User Info 2 field+the EHT by UHR STA User Info field, and the HE User Info field can be changed. That is, the Special User Info 1 field+the HE by UHR STA User Info field can be located before or after the Special User Info 2 field+the EHT by UHR STA User Info field (or the HE User Info field), the HE User Info field can also be located before or after the Special User Info 1 field+the HE by UHR STA User Info field (the Special User Info 2 field+the EHT by UHR STA User Info field), which is not limited in the embodiments of the present disclosure.

Embodiments of the present disclosure introduces a generalized signaling method to aggregate a wider range of TB A-PPDU UHR combinations (e.g., x-variant PPDUs with HE PPDUs). The proposed solution supports a wider range of TB A-PPDU for potential UHR combinations, reduces complexity and simplifies system design. The reserved values in the PHY Version Identifier and UL Bandwidth Extension subfields within the existing Special User Info field are repurposed, so as to accommodate future PPDU variants. The proposed solution also enhances the system's ability to adapt to changing network conditions and requirements by supporting a wider range of TB A-PPDU UHR combinations and potentially improves system performance in various scenarios. The proposed solution can be compatible with future PPDU variants and standards, which ensures the system's relevance and longevity. In addition, the proposed solution has backward compatibility by reusing existing fields and structures, which ensures seamless integration with legacy devices and systems, minimizing the impact on existing networks.

Next, embodiments of products related to the embodiments of the present disclosure will be described.

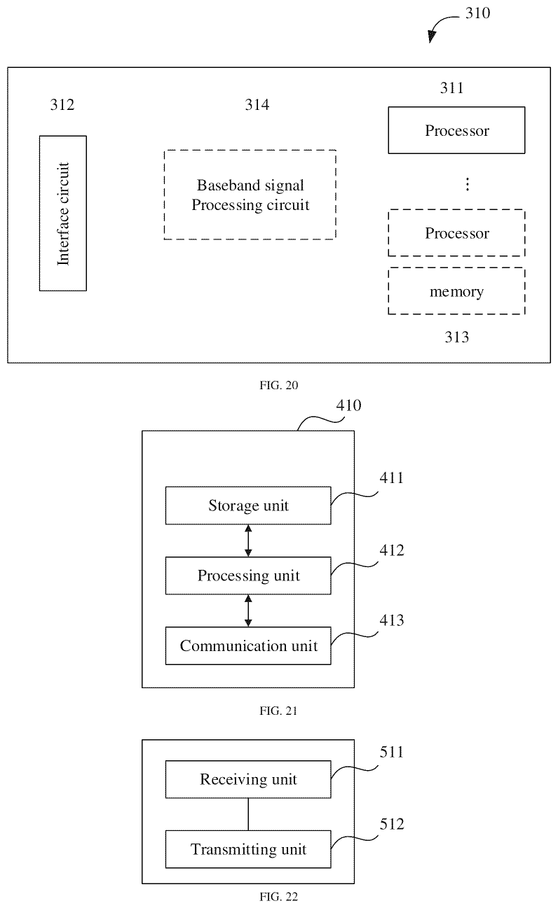

FIG. 20 illustrates an example apparatus 310 according to an implementation of the present disclosure. The apparatus 310 may be a communication device or an apparatus implemented in a communication device. For example, the apparatus 310 implemented in an STA/AP may be an integrated circuit, which in some instances may be referred to as a chip, a modem, a modem chip, a baseband chip, or a baseband processor. In some implementations, one or more integrated circuits can be packaged into a system-on-chip, a system-in-package, or a multi-chip module. The apparatus 310 can include one or more integrated circuits and other discrete components. In some implementations, the apparatus 310 may be a module within the STA/AP, or within the apparatus 110/120.

In an example, the apparatus 310 may include one or more processors 311, and an interface circuit 312. The apparatus 310 may further include a memory 313. The one or more processors 311 are configured to process signals and execute one or more communication protocols. The memory 313 is configured to store at least a part of corresponding computer program instructions and/or data. In an example, the one or more processors 311 execute the computer program instructions stored in the memory 313 to implement related operations (for example, inputting, outputting, receiving, and transmitting) in the method embodiments disclosed herein. In some implementations, the memory 313 being configured to store the corresponding computer program instructions and/or data may mean that the memory 313 is configured to store all of the corresponding computer program instructions and/or data for execution by the one or more processors 311. In some implementations, the memory 313 being configured to store the corresponding computer program instructions and/or data may mean that the memory 313 is configured to store a part of the corresponding computer program instructions and/or data. For example, the part of the corresponding computer program instructions and/or data may include computer program instructions and/or data that need to be currently executed by the one or more processors 311. Thus, the memory 313 may store different parts of computer program instructions and/or data for a plurality of times for the one or more processors 311 to perform related operations in the method embodiments disclosed herein. As a communication interface, the interface circuit 312 is configured to implement communication with another component. For example, the interface circuit 312 may communicate a signal with another apparatus or system, such as a radio frequency processing apparatus or another processor. The signal may include or carry information intended as a payload, such as user data, control information, etc. The signal may also include or carry information useful to a receiver, but not necessarily as a payload, such as a pilot signal or reference signal. Communicating the signal may include transmitting the signal to another component or device. Communicating the signal may additionally or alternatively include receiving the signal from another component or device. Transmitting the signal may include outputting the signal to a component or device that is directly or indirectly coupled to the interface circuit 312. Receiving the signal may include inputting or obtaining the signal from a component or device that is directly or indirectly coupled to the interface circuit 312. Optionally, to reduce a load of the one or more processors, a baseband signal processing circuit 314 may be also disposed to implement processing of at least a part of baseband signals, including signal demodulation, modulation, encoding, decoding, or the like.

The apparatus 310 may be the processor 210 (or 260) within the apparatus 110 (or 120), in some scenarios, or may be included within the processor 210 (or 260) within the apparatus 110 (or 120) in some scenarios. The apparatus 310 may be a baseband chip or may include a baseband chip. In some implementations, the apparatus 310 may be independently packaged into a chip. In some implementations, the apparatus 110 (or 120) includes different types of chips. The apparatus 310 may be packaged into a processor chip (for example, an SoC chip or an SIP chip) with the different types of chips. In some implementations, the apparatus 310 may be packaged into a chip with some or all of circuits of a radio frequency processing system that may further be included in the apparatus 110 (or 120).

FIG. 21 illustrates an example apparatus 410 according to an implementation of the present disclosure. The apparatus 410 may include corresponding modules or units configured to implement methods and/or implementations described herein. In some implementations, the apparatus 410 includes a processing unit 412 and a communication unit 413. The processing unit 412 may be configured to prepare the trigger frame/process the TB PPDUs received, and the communication unit 413 may be configured to transmit or receive the trigger frame, transmit TB PPDU(s) or receive TB PPDUs. Optionally, the apparatus 410 may further include a storage unit 411 configured to store apparatus program code (or instructions) and/or data.

The apparatus 410 may be an STA side apparatus, for example, an STA or a module in an STA, or a circuit or a chip responsible for a communication function in an STA. In some implementations, the apparatus 410 may be the apparatus 110. The processing unit 412 may be the processor 210. The communication unit 413 may comprise a receiving unit and/or a transmitting unit. The receiving unit and/or the transmitting unit may be the transmitter 201 and/or the receiver 203 respectively. The storage unit 411 may be the memory 208.

The apparatus 410 may be an AP side apparatus, for example, an AP or a module in an AP, or a circuit or a chip responsible for a communication function in an AP. In some implementations, apparatus 410 may be apparatus 120. The processing unit 412 may be the processor 260 (the scheduler 253 may also be included). The communication unit 413 may comprise a receiving unit and/or a transmitting unit. The receiving unit and/or the transmitting unit may be the transmitter 252 and/or the receiver 254 respectively. The storage unit 411 may be the memory 258.

In some implementations, when the apparatus 410 is an STA or a module in an STA, a function of the apparatus 410 may be implemented by one or more processors. Specifically, the processor may include a modem chip, or a system on chip (SoC) chip or an SIP chip that includes a modem core. A function of the communication unit 413 may be implemented by a transceiver circuit.

In some implementations, when the apparatus 410 is a circuit or a chip that is responsible for a communication function in an STA,—such as a modem chip, a system on chip (SoC) chip or an SIP chip that includes a modem core—a function of the processing unit 412 may be implemented by a circuit system within the chip which includes one or more processors. A function of the communication unit 413 may be implemented by an interface circuit or a data transceiver circuit on the chip.

It may be understood that the units in the apparatus 410 may be logical or functional. Each function may correspond to one functional unit, or two or more functions may be integrated into a single functional unit. In actual implementation, all or some of the units may be integrated into a single physical entity, or may be distributed across different physical entities. In addition, the functional units may be implemented in the form of hardware, software, or a combination of hardware and software. Whether a function is implemented in the form of hardware or software depends on particular applications and design constraint conditions of the technical solutions. A person skilled in the art may use different methods to implement the described functions for specific applications, but it should not be considered that the implementation goes beyond the scope of this disclosure.

In an example, a functional unit in any one of the apparatuses may be configured as one or more integrated circuits for implementing the methods disclosed herein, for example, as one or more application-specific integrated circuits (application-specific integrated circuits, ASICs), one or more central processing units (CPUs), one or more microprocessors or microprocessor units (MPUs), one or more microcontrollers or microcontroller units (MCUs), one or more digital signal processors (DSPs), one or more field programmable gate arrays (FPGAs), or a combination of these.

In an example, the storage unit 411 may include a random-access memory, a flash memory, a read-only memory, a programmable read-only memory, an electrically erasable programmable memory, and/or a register.

A processor may be referred to as a processor system, an application processor, a baseband processor, a processor circuit, or a processor core. The processor may include one or a combination of one or more central processing units (CPUs), one or more digital signal processors (DSPs), one or more microprocessors (microprocessor units, MPUs), one or more microcontrollers (microcontroller units, MCUs), one or more graphics processing units (GPUs), one or more field programmable gate arrays (FPGAs), one or more artificial intelligence processors (AI processors), or one or more neural network processing units (NPUs).

Memory or a storage unit may include one or more of the following storage media: a random access memory (RAM), a static random access memory (static RAM, SRAM), a dynamic random access memory (dynamic RAM, DRAM), a phase-change memory (PCM), a resistive random access memory (resistive RAM, ReRAM), a magnetoresistive random access memory (magnetoresistive RAM, MRAM), a ferroelectric random access memory (ferroelectric RAM, FRAM), a cache, a register, a read-only memory (ROM), a flash memory (flash memory), an erasable programmable read-only memory (erasable programmable ROM, EPROM), a hard disk, and the like. In an example, computer program instructions used to execute embodiments may be stored in a non-volatile memory, for example, at least a part of a memory or storage unit (for example, one or more of a ROM, a flash memory, an EPROM, or a hard disk). When a terminal runs, a part or all of corresponding computer program instructions may be loaded to a memory that has a higher transmission speed with the processor, for example, at least a part of a memory or a storage unit (for example, one or more of a RAM, an SRAM, a DRAM, a PCM, a RERAM, an MRAM, a FRAM, a cache, or a register), so that the processor executes the computer program instructions to perform the steps in the method embodiments disclosed herein.

In some aspects, a wireless communication apparatus is provided according to one or more embodiments of the present disclosure. The apparatus may include a transmitting unit configured to transmit a frame. The frame is used for requesting transmission of plural physical layer (PHY) protocol data units (PPDU), and the frame includes a first field indicating bandwidth information for the transmission of the plural PPDUs and a second field indicating bandwidth extended information for transmission of at least one of the plural PPDUs; where a channel for the transmission of the at least one of the plural PPDUs is indicated through a reserved combination of the first field and the second field.

In a possible design, the at least one PPDU of the plural PPDUs is requested to be transmitted on a secondary channel, and the plural PPDUs include a PPDU requested to be transmitted on a primary channel and the at least one PPDU.

In a possible design, the frame further includes a third field indicates whether a high efficiency (HE) PPDU from a HE station (STA) or a non-HE PPDU from a non-HE STA is requested to be present on a primary 160 MHz channel.

In a possible design, the plural PPDUs include the at least one of the plural PPDUs and the HE PPDU, and the third field indicates that the HE PPDU is present on the primary 160 MHz channel; where a channel for transmission of the HE PPDU by a non-access point (non-AP) HE STA is a primary 80 MHz channel within the primary 160 MHz channel, and is indicated by the first field.

In a possible design, the plural PPDUs include the at least one of the plural PPDUs and the non-HE PPDU, and the third field indicates that the non-HE PPDU is present on the primary 160 MHz channel; where a channel for transmission of the non-HE PPDU by the non-HE STA is a primary 80 MHz channel within the primary 160 MHz channel, and is indicated by the first field and the second field.

In a possible design, the at least one of the plural PPDUs includes one or more of:
an HE PPDU requested to be transmitted on a secondary 80 MHz channel by a non-AP ultra-high reliability (UHR) station (STA) in response to reception of the frame;
an EHT PPDU requested to be transmitted on a secondary 80 MHz channel or a secondary 160 MHz channel by a non-AP UHR STA in response to reception of the frame;
a UHR PPDU requested to be transmitted on a secondary 80 MHz channel or a secondary 160 MHz channel by a non-AP UHR STA in response to reception of the frame.

In a possible design, the frame further includes a physical layer (PHY) Version Identifier subfield corresponding to each of the at least one of the plural PPDUs for indicating a type of each of the at least one of the plural PPDUs.

In a possible design, the at least one of the plural PPDUs includes one PPDU, and a type of the one PPDU is indicated by a reserved value for the PHY Version Identifier subfield corresponding to the one PPDU.

In a possible design, the at least one of the plural PPDUs includes more than one PPDU, and types of different PPDUs among the more than one PPDU are indicated by different values carried in PHY Version Identifier subfields corresponding to the more than one PPDU respectively.

One of the reserved bits within the Common field (sixth field) can be utilized to indicate the presence of more than one Special User Info fields, thereby improving the decoding accuracy.

In a possible design, the frame further indicates a presence of Special User Info fields including the PHY Version Identifier subfields respectively.

In a possible design, the PHY Version Identifier subfield is assigned with a value of 1 for indicating a type of a requested PPDU being a UHR PPDU or a HE PPDU from a non-AP UHR STA.

In a possible design, the PHY Version Identifier subfield is assigned with a value of 7 for indicating a type of a requested PPDU being a HE PPDU from a non-AP UHR STA.

In a possible design, remaining reserved values within the PHY Version Identifier subfield are kept reserved for indicating other PPDU variant(s).

In a possible design, the channel indicated through the reserved combination of the first field and the second field is a secondary 80 MHz channel or a secondary 160 MHz channel.

In a possible design, in the reserved combination of the first field and the second field for indicating the secondary 80 MHz channel, the first field is assigned with a value of 2 and the second field is assigned with a value of 1 or 3.

In a possible design, in the reserved combination of the first field and the second field for indicating the secondary 160 MHz channel, the first field is assigned with a value of 2 and the second field is assigned with a value of 2.

In a possible design, in the reserved combination of the first field and the second field for indicating the secondary 160 MHz channel, the first field is assigned with a value of 3 and the second field is assigned with a value of 0.

In a possible design, bit 12 (B12) and bit 39 (B39) in a fourth field are re-purposed for other information.

In a possible design, when the at least one PPDU includes a UHR PPDU and an EHT PPDU, the frame further includes a fifth field between a UHR User Info field carrying user information of the UHR PPDU and a Special User Info field corresponding to the EHT PPDU; where the fifth field carries a frame check sequence (FCS) for the UHR PPDU.

In a possible design, the frame further indicates that the at least one PPDU includes the UHR PPDU and the EHT PPDU.

In a possible design, the indication of the at least one PPDU including the UHR PPDU and the EHT PPDU is carried in a Common Info field of the frame.

In a possible design, the first field is an uplink (UL) Bandwidth field in the frame.

In a possible design, the second field is an UL Bandwidth Extension subfield corresponding to the at least one of the plural PPDUs.

The wireless communication apparatus may be applied to the AP as described in the above method embodiments or may be the AP as described in the above method embodiments. It should be understood by a person skilled in the art that, the relevant description of the above unit(s) in the embodiments of the present disclosure may be understood with reference to the relevant description of the wireless communication method in the embodiments of the present disclosure.

FIG. 22 shows a block diagram of a wireless communication apparatus according to one or more embodiments of the present disclosure. As shown in FIG. 22, the wireless communication apparatus may include a receiving unit 511 and a transmitting unit 512. The receiving unit 511 is configured to receive a frame, where the frame is used for requesting transmission of plural physical layer (PHY) protocol data units (PPDU), and the frame includes a first field indicating bandwidth information for the transmission of the plural PPDUs and a second field indicating bandwidth extended information for transmission of at least one of the plural PPDUs; where a channel for the transmission of the at least one of the plural PPDUs is indicated through a reserved combination of the first field and the second field. The transmitting unit 512 is configured to transmit a PPDU among the plural PPDUs based on the frame. It should be noted that, the functions of the transmitting unit and the receiving unit may also be implemented by a transceiving unit.

In a possible design, the at least one PPDU of the plural PPDUs is requested to be transmitted on a secondary channel, and the plural PPDUs include a PPDU requested to be transmitted on a primary channel and the at least one PPDU.

In a possible design, the frame further includes a third field indicates whether a high efficiency (HE) PPDU from a HE station (STA) or a non-HE PPDU is requested to be present on a primary 160 MHz channel.

In a possible design, the plural PPDUs include the at least one of the plural PPDUs and the HE PPDU, and the third field indicates that the HE PPDU is present on the primary 160 MHz channel; where a channel for transmission of the HE PPDU by a non-access point (non-AP) HE STA is a primary 80 MHz channel within the primary 160 MHz channel, and is indicated by the first field.

In a possible design, the plural PPDUs include the at least one of the plural PPDUs and the non-HE PPDU, and the third field indicates that the non-HE PPDU is present on the primary 160 MHz channel; where a channel for transmission of the non-HE PPDU by the non-HE STA is a primary 80 MHz channel within the primary 160 MHz channel, and is indicated by the first field and the second field.

In a possible design, the at least one of the plural PPDUs includes one or more of:
an HE PPDU requested to be transmitted on a secondary 80 MHz channel by a non-AP ultra-high reliability (UHR) station (STA) in response to reception of the frame;
an EHT PPDU requested to be transmitted on a secondary 80 MHz channel or a secondary 160 MHz channel by a non-AP UHR STA in response to reception of the frame;
a UHR PPDU requested to be transmitted on a secondary 80 MHz channel or a secondary 160 MHz channel by a non-AP UHR STA in response to reception of the frame.

In a possible design, the frame further includes a physical layer (PHY) Version Identifier subfield corresponding to each of the at least one of the plural PPDUs for indicating a type of each of the at least one of the plural PPDUs.

In a possible design, the at least one of the plural PPDUs includes one PPDU, and a type of the one PPDU is indicated by a reserved value for the PHY Version Identifier subfield corresponding to the one PPDU.

In a possible design, the at least one of the plural PPDUs includes more than one PPDU, and types of different PPDUs among the more than one PPDU are indicated by different values carried in PHY Version Identifier subfields corresponding to the more than one PPDU respectively.

One of the reserved bits within the Common field can be utilized to indicate the presence of more than one Special User Info fields, thereby improving the decoding accuracy.

In a possible design, the frame further indicates a presence of Special User Info fields including the PHY Version Identifier subfields respectively.

In a possible design, the PHY Version Identifier subfield is assigned with a value of 1 for indicating a type of a requested PPDU being a UHR PPDU or a HE PPDU from a non-AP UHR STA.

In a possible design, the PHY Version Identifier subfield is assigned with a value of 7 for indicating a type of a requested PPDU being a HE PPDU from a non-AP UHR STA.

In a possible design, remaining reserved values within the PHY Version Identifier subfield are kept reserved for other PPDU variant(s).

In a possible design, the channel indicated through the reserved combination of the first field and the second field is a secondary 80 MHz channel or a secondary 160 MHz channel.

In a possible design, in the reserved combination of the first field and the second field for indicating the secondary 80 MHz channel, the first field is assigned with a value of 2 and the second field is assigned with a value of 1 or 3.

In a possible design, in the reserved combination of the first field and the second field for indicating the secondary 160 MHz channel, the first field is assigned with a value of 2 and the second field is assigned with a value of 2.

In a possible design, in the reserved combination of the first field and the second field for indicating the secondary 160 MHz channel, the first field is assigned with a value of 3 and the second field is assigned with a value of 0.

In a possible design, bit 12 (B12) and bit 39 (B39) in a fourth field are re-purposed for other information.

In a possible design, when the at least one PPDU includes a UHR PPDU and an EHT PPDU, the frame further includes a fifth field between a UHR User Info field carrying user information of the UHR PPDU and a Special User Info field corresponding to the EHT PPDU; where the fifth field carries a frame check sequence (FCS) for the UHR PPDU.

In this case, UHR STA will decode only its UHR Special User Info field, its UHR User Info field, and a corresponding FCS user Info field, thereby reducing the amount of data to be processed, and improving the decoding efficiency.

In a possible design, the frame further indicates that the at least one PPDU includes the UHR PPDU and the EHT PPDU.

In a possible design, the indication of the at least one PPDU including the UHR PPDU and the EHT PPDU is carried in a Common Info field of the frame.

In a possible design, the first field is an uplink (UL) Bandwidth field in the frame.

In a possible design, the second field is an UL Bandwidth Extension subfield corresponding to the at least one of the plural PPDUs.

The wireless communication apparatus may be applied to the STA as described in the above method embodiments or may be the STA as described in the above method embodiments. It should be understood by a person skilled in the art that, the relevant description of the above units in the embodiments of the present disclosure may be understood with reference to the relevant description of the wireless communication method in the embodiments of the present disclosure.

In some aspects of the present disclosure, there is provided a wireless communication apparatus including processing circuitry for executing any of the above methods. It should be understood that the apparatus can execute the steps in the above method embodiments, which will not be repeated here.

In some aspects of the present disclosure, there is provided a chip, including an input/output (I/O) interface and a processor, where the processor is configured to call and run computer execution instructions stored in a memory, to enable a device installing with the chip to execute any of the above methods.

In some aspects of the present disclosure, there is provided a computer-readable medium storing computer execution instructions which, when executed by a processor, cause the processor to execute any of the above methods.

In some aspects of the present disclosure, there is provided a computer program product including computer execution instructions which, when executed by a processor, cause the processor to execute any of the above methods.

In some aspects of the present disclosure, there is provided a computer program including computer execution instructions which, when executed by a processor, cause the processor to execute any of the above methods.

Although the present disclosure describes methods and processes with steps in a certain order, one or more steps of the methods and processes may be omitted or altered as appropriate. One or more steps may take place in an order other than that in which they are described, as appropriate.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein. The machine-executable instructions may be in the form of code sequences, configuration information, or other data, which, when executed, cause a machine (e.g., a processor or other processing device) to perform steps in a method according to examples of the present disclosure.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may include a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

Although embodiments have been described above with reference to the accompanying drawings, those of skill in the art will appreciate that variations and modifications may be made without departing from the scope thereof as defined by the appended claims.

1. A wireless communication method, comprising:
transmitting a frame, wherein the frame is used for requesting transmission of plural physical layer (PHY) protocol data units (PPDU), and the frame comprises a first field indicating bandwidth information for the transmission of the plural PPDUs and a second field indicating bandwidth extended information for transmission of at least one of the plural PPDUs; wherein a channel for the transmission of the at least one of the plural PPDUs is indicated through a reserved combination of the first field and the second field.

2. The method according to claim 1, wherein the frame further comprises a third field indicates whether a high efficiency (HE) PPDU from a HE station (STA) or a non-HE PPDU from a non-HE STA is requested to be present on a primary 160 MHz channel.

3. The method according to claim 2, wherein the plural PPDUs comprise the at least one of the plural PPDUs and the HE PPDU, and the third field indicates that the HE PPDU is present on the primary 160 MHz channel;
wherein a channel for transmission of the HE PPDU by a non-access point (non-AP) HE STA is a primary 80 MHz channel within the primary 160 MHz channel, and is indicated by the first field.

4. The method according to claim 2, wherein the plural PPDUs comprise the at least one of the plural PPDUs and the non-HE PPDU, and the third field indicates that the non-HE PPDU is present on the primary 160 MHz channel;
wherein a channel for transmission of the non-HE PPDU by the non-HE STA is a primary 80 MHz channel within the primary 160 MHz channel, and is indicated by the first field and the second field.

5. The method according to claim 1, wherein the at least one of the plural PPDUs comprises one or more of:
an HE PPDU requested to be transmitted on a secondary 80 MHz channel by a non-AP ultra-high reliability (UHR) station (STA) in response to reception of the frame;
an EHT PPDU requested to be transmitted on a secondary 80 MHz channel or a secondary 160 MHz channel by a non-AP UHR STA in response to reception of the frame;
a UHR PPDU requested to be transmitted on a secondary 80 MHz channel or a secondary 160 MHz channel by a non-AP UHR STA in response to reception of the frame.

6. The method according to claim 1, wherein the frame further comprises a physical layer (PHY) Version Identifier subfield corresponding to each of the at least one of the plural PPDUs for indicating a type of each of the at least one of the plural PPDUs.

7. The method according to claim 6, wherein the at least one of the plural PPDUs comprises one PPDU, and a type of the one PPDU is indicated by a reserved value for the PHY Version Identifier subfield corresponding to the one PPDU.

8. The method according to claim 6, wherein the at least one of the plural PPDUs comprises more than one PPDU, and types of different PPDUs among the more than one PPDU are indicated by different values carried in PHY Version Identifier subfields corresponding to the more than one PPDU respectively.

9. The method according to claim 8, wherein the frame further indicates a presence of Special User Info fields comprising the PHY Version Identifier subfields respectively.

10. The method according to claim 6, wherein the PHY Version Identifier subfield is assigned with a value of 1 for indicating a type of a requested PPDU being a UHR PPDU or a HE PPDU from a non-AP UHR STA.

11. The method according to claim 6, wherein the PHY Version Identifier subfield is assigned with a value of 7 for indicating a type of a requested PPDU being a HE PPDU from a non-AP UHR STA.

12. The method according to claim 7, wherein remaining reserved values within the PHY Version Identifier subfield are kept reserved for indicating other PPDU variants.

13. The method according to claim 1, wherein the channel indicated through the reserved combination of the first field and the second field is a secondary 80 MHz channel or a secondary 160 MHz channel.

14. The method according to claim 13, wherein in the reserved combination of the first field and the second field for indicating the secondary 80 MHz channel, the first field is assigned with a value of 2 and the second field is assigned with a value of 1 or 3.

15. The method according to claim 13, wherein in the reserved combination of the first field and the second field for indicating the secondary 160 MHz channel, the first field is assigned with a value of 2 and the second field is assigned with a value of 2.

16. The method according to claim 13, wherein in the reserved combination of the first field and the second field for indicating the secondary 160 MHz channel, the first field is assigned with a value of 3 and the second field is assigned with a value of 0.

17. The method according to claim 1, wherein when the at least one PPDU comprises a UHR PPDU and an EHT PPDU, the frame further comprises a fifth field between a UHR User Info field carrying user information of the UHR PPDU and a Special User Info field corresponding to the EHT PPDU;
wherein the fifth field carries a frame check sequence (FCS) for the UHR PPDU.

18. The method according to claim 17, wherein the frame further indicates that the at least one PPDU comprises the UHR PPDU and the EHT PPDU; wherein the indication of the at least one PPDU comprising the UHR PPDU and the EHT PPDU is carried in a Common Info field of the frame.

19. A wireless communication method, comprising:
receiving a frame, wherein the frame is used for requesting transmission of plural physical layer (PHY) protocol data units (PPDU), and the frame comprises a first field indicating bandwidth information for the transmission of the plural PPDUs and a second field indicating bandwidth extended information for transmission of at least one of the plural PPDUs; wherein a channel for the transmission of the at least one of the plural PPDUs is indicated through a reserved combination of the first field and the second field; and
transmitting a PPDU among the plural PPDUs based on the frame.

20. An apparatus comprising:
one or more processors; and
a memory storing instructions which, when executed by the one or more processors, cause the apparatus to:
transmit a frame, wherein the frame is used for requesting transmission of plural physical layer (PHY) protocol data units (PPDU), and the frame comprises a first field indicating bandwidth information for the transmission of the plural PPDUs and a second field indicating bandwidth extended information for transmission of at least one of the plural PPDUs; wherein a channel for the transmission of the at least one of the plural PPDUs is indicated through a reserved combination of the first field and the second field.
